(19) United States
(12) Patent Application Publication
(10) Pub. No.: US 2025/0155987 A1
(43) Pub. Date: May 15, 2025

(54) BRAIN MACHINE INTERFACE FOR PERFORMING SUSTAINED ACTIONS USING DISCRETE COMMANDS

(71) Applicants: BROWN UNIVERSITY, Providence, RI (US); THE GENERAL HOSPITAL CORPORATION, Boston, MA (US); The United States Government as Represented by the Department of Veterans Affairs, Washington, DC (US)

(72) Inventors: Leigh Hochberg, Brookline, MA (US); Thomas Hosman, Providence, RI (US); Jacob Gusman, Waban, MA (US); John D. Simeral, East Greenwich, RI (US); Carlos Vargas-Irwin, Providence, RI (US)

(21) Appl. No.: 18/946,156

(22) Filed: Nov. 13, 2024

Related U.S. Application Data
(60) Provisional application No. 63/598,515, filed on Nov. 13, 2023.

(51) Int. Cl. G06F 3/01

(52) U.S. Cl. CPC G06F 3/017; G06F 3/015

(57) ABSTRACT

Sustained commands, such as drag and drop, scrolling, holding a position, and the like, can be performed by a user mentally controlling a controllable device via a brain-machine interface (BMI). Neural signals can be recorded by at least one neural recording device associated with a user and sent to the BMI, which can extract neural features from the neural signals. The BMI, which can include at least a Latch decoder, which can include a Gesture Type decoder and an Attempt decoder, can determine whether an action should be performed and a period of time the action should be held. If the action should be performed, then the controllable device can be controlled to perform the action for the period of time. If the action should not be performed, then the controllable device can be controlled to remain in a waiting state and/or a previous state.

### CROSS-REFERENCE TO RELATED APPLICATIONS

This application claims the benefit of U.S. Provisional Application Ser. No. 63/598,515, filed 13 Nov. 2023, entitled “A NOVEL OPTICAL METHOD FOR DECODING SUSTAINED GRASPS FOR USE IN INTRACORTICAL BRAIN COMPUTER INTERFACES”. The entirety of this application is incorporated by reference for all purposes.

### GOVERNMENT FUNDING

This invention was made with government support under grant number U01 DC017844 awarded by the National Institutes of Health, grant number A2295R awarded by the U.S. Department of Veteran Affairs, and grant number 19CSLOI34780000 awarded by the American Heart Association. The government has certain rights in the invention.

### TECHNICAL FIELD

The present disclosure relates generally to brain machine interfaces (BMIs) and, more specifically, to systems and methods for mentally controlling the performance of sustained actions in response to discrete intended gestures.

### BACKGROUND

Brain-machine interfaces (BMIs), such as intracortical brain-computer interfaces (iBCIs), can give users the ability to control devices, like computers, robots, and the like, with neural signals. The users can be disabled (e.g., people with tetraplegia and/or other conditions that can negatively impact motor function) and/or able-bodied. Traditionally, BMIs connect a short duration neural signal to a short duration discrete command, for example, using a discrete imagined or attempted gesture and/or posture of an arm, a hand, facial feature, or the like or a thought of an image or drawing an image. However, many everyday actions using controllable devices (e.g., holding one or more objects for duration of time, pressing a button for a desired duration, clicking and dragging an element with a computer mouse, or the like) require a sustained control signal that cannot be sufficiently decoded by current BMIs in response to discrete neural inputs.

Sustained gestures and/or postures can be problematic for a BMI to decode because static posture information is not typically well represented by the neural signals detected using BMIs. Motor commands such as the initiation of a specific gesture can be clearly decoded, but when discrete gestures are sustained for durations longer than one or two seconds, their associated neural signals become less distinct and difficult to decode. To date, the majority of BMI neural decoding systems circumvent these challenges by employing velocity-based control logic to make discrete or continuous changes in a controlled state. However, velocity-based control logic can be less intuitive for users if velocity is not a part of the controlled command (e.g., holding an object for a period of time does not involve velocity changes) and can be prone to decoding difficulties when multiple gestures can be decoded over long hold periods.

### SUMMARY

The present disclosure illustrates accurately, mentally controlling an external device to perform sustained actions using discrete commands. The control can be accomplished using a brain machine interface (BMI) to decode neural signals predictive of discrete known gestures. It is important to note that the BMI can control the external device based on a user at least thinking of performing a known gesture and that actually performing the gesture is not necessary.

One aspect of the present disclosure is a system for performing sustained actions via a BMI. The system can include at least one neural recording device that can record at least one neural signal of a user, a controllable device that can perform at least one action, and a controller in communication with the at least one neural recording device and the controllable device. The controller can include a non-transitory memory storing instructions and a processor configured to execute the stored instructions to do the following. Receive the at least one neural signal of the user from the at least one neural recording device. Extract at least one neural feature from the at least one neural signal of the user. Execute a Latch decoder, which includes a Gesture Type decoder and an Attempt decoder, that can determine whether an action should be performed and a period of time the action should be held. If the action should be performed, then the controllable device can be controlled to perform the action for the period of time (e.g., based on one or more outputs from the Latch decoder). If the action should not be performed, then the controllable device can be controlled to remain in a waiting state and/or a previous state (e.g., based on one or more outputs from the Latch decoder).

Another aspect of the present disclosure is a method for performing sustained actions with a BMI. The method can be performed by a system comprising at least a processor and a non-transitory memory, which in communication with at least one neural recording device and a controllable device. The method includes receiving at least one neural signal of a user from the at least one neural recording device; extracting at least one neural feature from the at least one neural signal of the user; and executing a Latch decoder including a Gesture Type decoder and an Attempt decoder to determine whether the controllable device should perform an action and a period of time the action should be held. If the action should be performed, then the method can include controlling the controllable device to perform the action for the period of time (e.g., outputting one or more action commands). If the action should not be performed, then controlling the controllable device to remain in a waiting state and/or a previous state (e.g., outputting a Null command).

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 shows a block diagram of a brain machine interface (BMI) system;

FIG. 2 shows a block diagram of the decoders within the controller of the BMI system of FIG. 1;

FIGS. 3 and 4 show a block diagram of actions performed by the Gesture Type decoder and the Attempt decoder of the controller of FIG. 2 at different times;

FIG. 5 shows a block diagram depicting the entire Latch Decoder of FIG. 2 in detail;

FIG. 6 shows a block diagram depicting the Lock Decoder of FIG. 2 in greater detail;

FIG. 7 shows a block diagram of an alternate BMI system with a combination Gesture Type and Lock decoder;

FIG. 8 shows a block diagram depicting the Lock decoder of FIG. 6 in greater detail;

FIG. 9 is a process flow diagram showing a method for using a Latch decoder;

FIG. 10 is a process flow diagram showing a method for using a Gesture Type decoder;

FIG. 11 is a process flow diagram showing a method for using an Attempt decoder;

FIG. 12 is a process flow diagram showing a method for using a Lock decoder;

FIG. 13 shows illustrations of a task of an experiment for long duration computer control;

FIGS. 14-19 show illustrations and/or graphical representations of experimental methods and results;

FIG. 20 shows illustrations of systems and participants for an experiment with a soft-robotic glove (SRG);

FIG. 21 shows an illustration and a graphical representation of four postures possible for an SRG in the experiment;

FIG. 22 shows illustrations of continuous and toggle control of the SRG; and

FIGS. 23 and 24 shows illustrations and graphical representations of methods and results of the experiment.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an,” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “brain machine interface (BMI)” refers to a device or system (including at least one non-transitory memory and at least one processor) that enables communication between a user's nervous system (e.g., brain, central nervous system, peripheral nervous system, or the like) and a controllable device to allow the user to mentally control at least an aspect of the controllable device. As an example, the BMI can acquire neural signals (e.g., via one or more electrodes), analyze the neural signals (e.g., to detect/decode/predict a neural activity pattern indicative of a thought about an intended posture, gesture, or the like), identify a portion of the neural signals as a neural activity pattern, and translate the neural activity pattern identified in the neural signals into commands that are relayed to the controllable device (e.g., based on a posture/gesture profile for the user stored in memory). One example of a BMI is a Brain Computer Interface (BCI). An alternative version of a BMI can be a BMI that can perform control based on electromyography (EMG) signals resulting from muscle contractions.

As used herein, the term “mental control” refers to one or more neural activity patterns indicative of a thought of the user intending to perform a posture, gesture, of the like to voluntarily cause an action to be performed. The term mental control generally means a computerized/controllable action performed based on the detection of mental/neural activity related to intended actions.

As used herein, the terms “thinking of attempting”, “intending”, “imagining”, and the like, can be used interchangeably herein to refer to a user's thought(s) of making the user's body act in a certain way to perform an action (e.g., assume/hold a certain posture or gesture), regardless of whether the body actually acts in the certain way in response to the thought. For example, a brain-machine interface can be employed to detect a user's one or more thoughts related to movement and/or motor functions via neural signals

As used herein, the term “gesture” refers to one or more movements or static postures at the end of a movement of at least one portion of a user's body (e.g., finger, hand, arm, face, toe, foot, leg, or the like) at a given time or over a given period of time. Movements include velocity to move through a number of intermediate postures from a starting position to an end position (e.g., moving a hand from a relaxed position to a thumbs up). The term posture refers to a fixed, static position (that does not rely on velocity) of at least a portion of a user's body (e.g., the user's body, limb, extremity, appendage, face, or the like) in space at a given time (e.g., the relaxed hand or the thumbs up hand). For example, a hand posture can include specific held position of at least one of the hand, the wrist, or at least one finger (e.g., a held position of a thumbs up, a thumbs down, a fist, a flexed finger, an extended finger, or the like.). In another example, a facial posture can include the held position of a lifted eyebrow or a raised corner of a mouth. A static posture is distinct from a gesture, which has a velocity (e.g., a gesture can include the act of swiping a finger to the left, right, up, or down, while a posture can include only a position at the beginning or end of the swipe). Multiple postures at different given times may be sequentially combined together to represent, convey, or the like, a gesture, without necessarily iterating the full path of movement, for example swiping left to right can be represented by pointing left and then pointing right.

As used herein the terms “short term” and “finite” can be used interchangeably in reference to a gesture, command, and/or action that occurs within a predetermined (short) period of time. For instance, a short-term gesture can occur within one second or less, half a second or less, or the like, and can produces a single command and associated action that is not held for any noticeable length of time (e.g., one click, type one letter, move in a direction with multiple short-term commands necessary to move a cumulative distance, etc.).

As used herein the term “long duration”, “sustained”, or “held” can be used interchangeably and can be used in reference to a gesture, command, and/or action that occurs longer than the predetermined period for short term or finite. For instance, a long duration or held gesture can occur for longer than one second, half a second, or the like and can produce a command and associated action that is held for a noticeable length of time (e.g., holding a click, holding a grip with a soft robotic glove, or the like). Distinctions between different lengths of long duration or held gesture(s), command(s), and/or action(s) can be made based on a duration of neural signal decoding.

As used herein, the term “controllable device” can refer to any device that can receive a command signal and then complete at least one action based on the command signal. Examples of controllable devices include, but are not limited to, a computer, a tablet, a mobile device, an environmental control element, a speech activation system, a robotic device, a prosthetic (e.g., for an arm, leg, hand, etc.), a soft robotic wearable (e.g., a glove), or the like.

As used herein, the terms “user” and “subject” can be used interchangeably to refer to any person, or animal, that can transmit neural signals to the BMI device. The person can be, for example, an individual with at least partial paralysis, an individual missing at least part of a limb or extremity, an able-bodied individual, or the like.

As used herein, the term “electrodes” refers to one or more conductors used to record and/or transmit an electrical signal (e.g., transmitting neural signals from a user's brain to a BMI). For example, electrodes can be on or against the skull (e.g., electroencephalography (EEG) electrodes or the like), near the brain (e.g., electrocorticography (ECoG) electrodes, any electrodes recording neural signals from blood vessels on or in the brain, or the like), and/or implanted in the brain (e.g., intracortical electrodes, deep brain electrodes, or the like). In some instances, two or more electrodes can be part of an array.

As used herein, the term “neural signals” refers to signals generated by a user's nervous system (e.g., at least a portion of the brain, like the cerebral cortex, the central nervous system, the peripheral nervous system, or the like). Neural signals can be recorded as electrical signal by one or more electrodes, as optical waves with near infrared spectroscopy (NIRS), as mechanical waves by one or more ultrasound transducers, or the like and transmitted to a BMI. For example, a plurality of electrodes can record an array of neural signals. At least a portion of the neural signals can be related to thought and/or intended motor actions (but only when the user actually thinks and/or intends the motor actions (e.g., gesture, posture, etc.)).

As used herein, the term “neural activity pattern” refers to at least a portion of one or more neural signals comprising recognizable neural features, such as threshold crossings and local field potential (e.g., spike band power), indicative of a specific thought of a subject, which can include an intended posture/gesture.

As used herein, the term “sustained” can refer to a time period for an action being held beyond the time a single discrete command would normally cause the action to last. For instance, depending on the action, a sustained action can be 5 ms or longer, 50 ms or longer, 1 second or longer, 5 seconds or longer, 30 seconds or longer, 1 minute or longer, 10 minutes or longer, 30 minutes or longer, or the like. For example, a single click of a mouse can take around 2 ms to 4 ms but a sustained click can last for 4 ms and greater (e.g., the length of entire seconds depending on utility of the action).

As used herein, the term “real time” refers to a time period, within 100 milliseconds, 50 milliseconds, 20 milliseconds, 10 milliseconds, or the like, that seems virtually immediate to a user. For example, an input (neural signals from the user) can be processed within several milliseconds so that the output (control signal after processing the neural signals) is available virtually immediately.

### II. Overview

Traditionally, an able-bodied user can use postures and/or gestures as inputs to a controllable device, but in certain circumstances, users (e.g., medically compromised and/or able bodied) are unable (or does not desire) to use such postures and/or gestures as inputs. Intracortical brain-computer interfaces (iBCIs) (one example of a brain machine interface (BMI)) utilize neural signals from motor areas of the brain to allow users who cannot or do not want to use physical gestures to control external devices like computers, tablets, soft robotic wearables, prosthetics, robots, or the like using thought and/or attempted gestures. Recent work has shown that individual finger movements, complex hand gestures, and even handwriting can be reliably decoded using iBCIs. However, each of these control signals represent transient motor commands that evolve over the course of 1 or 2 seconds and are decoded as discrete events. Discrete events alone cannot provide full control of computers, tablets, robotics, and the like. For example, many actions important to everyday activities, such as holding objects, pressing a button for a desired duration, clicking and dragging with a computer mouse, and the like, require maintaining a specific posture (sometimes with additional gestures) over a sustained time.

Traditional neural decoding methods have not been able to accurately decode these longer held postures and/or gestures over the entire intended length of the hold. Without wishing to be bound by theory, it is believed that neurons in motor and premotor cortices are “phasic-tonic” and tend to fire more robustly at the beginning of an isometric grasp attempt, but less so as the grasp force is maintained over time. Thus, neural activity during initial phasic responses tend to correlate with EMG, but sustained tonic activity is only weakly correlated with motor output. Additionally, the tuning of motor cortical neurons to different motor commands can decrease over the course of a sustained isometric hold, can make it more difficult for a neural decoder to reliably differentiate between different sustained actions held over time. Furthermore, grasp decoding of sustained holds can be attenuated during concurrent arm translation (e.g., holding an object and moving an arm, click and drag, or the like.

The systems and methods described herein provide responsive and consistent mental control of a controllable device to perform sustained actions via an intuitive BMI. The BMI can decode discrete postures and/or gestures and sustained holds of those postures and/or gestures to determine the action for the controllable device to perform and the length of time the action should be held before releasing. The BMI can include a Latch decoder that can include both a Gesture Type decoder and an Attempt decoder. The BMI can also optionally include a Lock decoder configured to lock an action so the user does not need to sustain a thought and/or can control other actions simultaneous with the held action. These systems and methods can facilitate intuitive mental control of everyday electronics, such as scrolling, swiping, or dragging and dropping on a computer, smartphone, or tablet; control of assistive technologies, such as soft robotic gloves, exoskeletons, or the like for improved and/or restored motor functions; control of robotics in manufacturing, exploration, or the like where intuitive remote control can be used.

### III. Systems

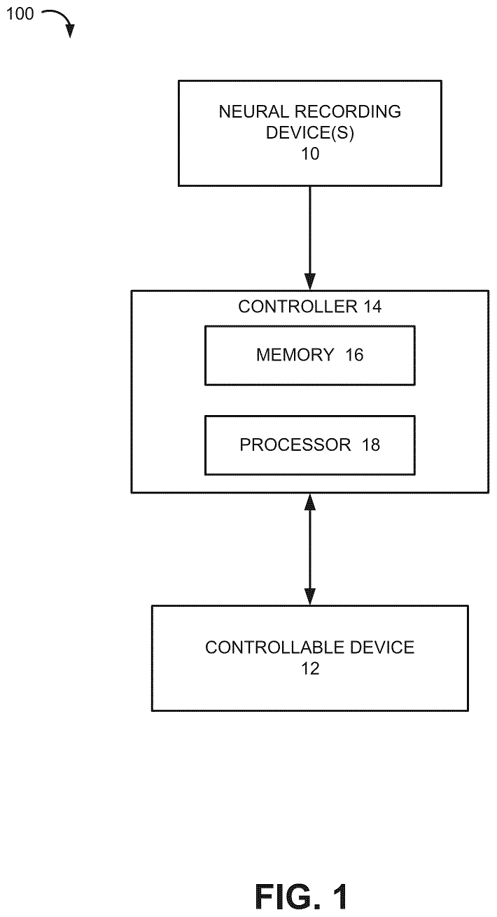

FIG. 1 shows a system 100 that can provide intuitive mental control of sustained actions of a controllable device 12 in a multi-gesture context. The system 100 can decode multiple gestures over extended hold periods, thus providing naturalistic control of sustained actions (such as “drag and drop” control of a cursor, a robotic end effector, and other devices/systems that can utilize sustained input with or without simultaneous control of other degrees of freedom). The system 100 can include at least one neural recording device 10, a controllable device 12, and a controller 14 that can embody a brain machine interface (BMI). The controller 14 can be in communication (wired and/or wireless) (e.g., electrical, optical, or the like) with the at least one neural recording device 10 and the controllable device 12 to provide mental control of the controllable device. While not shown for ease of illustration and description it should be understood that the system 100 can include any other common components for functioning such as a battery and/or power source, circuitry, wireless transmitter(s), traditional control and notification interfaces (e.g., display, keyboard, mouse, touch screen, mechanical buttons or the like) for use by a technician, caregiver, and/or medical professional, and/or the like.

The at least one neural recording device 10 can record at least one neural signal of a user and send the recorded at least one neural signal to the controller 14. The at least one neural recording device 10 can include at least one electrode that can record at least one neural signal from the user's nervous system (e.g., from a brain of the user). The neural recording device(s) 10 can be, for example, microelectrode arrays that include the electrode(s) each with a channel for recording a different neural signal. Without wishing to be bound by theory it is believed that the precentral gyrus (left and right) feature heavily in providing motor control related signals to the rest of the body.

Examples of the neural recording device 10 are shown below. It should be understood that these examples are not meant to be limiting. The electrode(s) of the neural recording device(s) 10 can each be positioned on and/or implanted into the brain of the subject. The electrode(s) of the neural recording device(s) 10 can be on the skull (e.g., electroencephalography (EEG) electrodes or the like), near the brain (e.g., electrocorticography (ECOG) electrodes, any electrodes recording neural signals from blood vessels on or in the brain, or the like), and/or implanted in the brain (e.g., intracortical electrodes, deep brain electrodes, or the like). The neural recording device(s) 10 can be positioned in and/or over one or both hemispheres of the brain depending on the neural signals intended to be recorded. For instance, the neural recording device(s) 10 can be one or more multi-channel microelectrode arrays that can be implanted on a left precentral gyrus of the user to detect and record neural signals at least related to intended/imagined gestures of the upper body (e.g., gestures and/or postures of a hand, a wrist, and/or at least one digit, or the like).

In one example, the neural recording device(s) 10 can be at least one multi-channel intracortical microelectrode array positioned on and/or implanted into the brain. For example, two 96-channel intracortical microelectrode arrays can be chronically implanted into the precentral gyrus of the subject's brain.

In another example, the neural recording device(s) 10 may also include implanted and/or surface electrodes able to record from a portion of the subject's peripheral nervous system (e.g., for an amputee). The neural recording device(s) 10 can be connected to the controller 14 by a wired connection, a wireless connection, or an at least partially wired and wireless connection. The neural recording device(s) 10 can record and send neural signals to the controller 14 at real- and/or near real-time rates to facilitate the intuitiveness of mentally controlling the controllable device 12, for example every 1 millisecond or less, every 5 milliseconds or less, every 10 milliseconds or less, every 20 milliseconds or less, every 50 milliseconds or less, every 100 milliseconds or less, or the like.

The controllable device 12 can receive one or more control signals (e.g., commands) from the controller 14 in response to the neural signals received from the neural recording device(s) (e.g., over a wired connection, a wireless connection, or an at least partially wired and wireless connection). The controllable device 12 can perform one or more actions based on the one or more control signals. In some instances, the controllable device 12 can also send feedback data (e.g., data related to an aspect of the controllable device, data related to the action performed by the controllable device, etc.) back to the controller 14. While a single controllable device 14 is shown and described throughout, it should be understood that the system can include one or more controllable devices that can be swapped in and/or out at any given time (e.g., the user can choose to switch the controllable device that is being controlled through the BMI at any time).

The controllable device 12 can be any device that includes at least a processor and/or circuitry that can receive at least one control signal from the controller 14 and then execute at least one action based on the at least one control signal. The controllable device 12 may include a non-transitory memory, a display, a user interface, or the like. For example, the controllable device 12 can be a device including at least a processor and a visual display (such as a computer, a tablet, or a smartphone), an environmental control element, a speech activation system, a robotic device, a prosthetic, a soft robotic wearable, or the like. For example, the controllable device 12 can be a computer, smartphone, or tablet that can include at least a processor and a visual display where the actions are functions of the computer traditional controlled with a touch screen, keyboard, or mouse (such as swiping, scrolling, holding a click, dragging and dropping, or the like). The controllable device 12 can also be a soft robotic wearable such as a glove, a prosthetic, a functional electrical stimulation system (e.g., at least one electrode position on at least one muscle of a user to cause a muscle contraction), and/or an exoskeleton that can be controlled to perform (or cause the user to perform) one or more motor functions a user cannot perform on their own (e.g., because of a disease, disorder, injury, or the like that causes one or more motor impairments). In another example, the controllable device 12 can be an environmental control element, such as a motorized wheelchair, a smart piece of furniture, a smart thermostat, smart lightbulb, security/safety devices (e.g., cameras, alarms, or the like), or the like. Where smart refers to any objects that include circuits and/or computer components that can cause an action. In a further example, the controllable device 12 can be a work system, in the environment of the subject or remote from the subject, such as a manufacturing robot putting together a product, a computer, tablet, or smartphone running a software (e.g., word processing, computational, CAD, video, or the like), a computerized train (e.g., where the subject is a train engineer), an elevator (e.g., where the subject is a concierge), or the like.

The controller 14 can perform the functions of a brain machine interface and can connect the neural recording device(s) 10 with the controllable device 12 to allow mental control. The controller 14 can receive neural recordings, analyze and decode the neural signals to determine one or more control signals (e.g., commands) for a given controllable device 12, and send the one or more control signals to the controllable device. In some instances, the controller 14 can also receive feedback signals from the controllable device 12. The controller 14 can include at least a memory 16 (e.g., a non-transitory memory) that can store instructions and a processor 18 that can execute the instructions. The memory 16 and the processor 18 can be embodied as separate and/or combined hardware devices and/or software aspects. For example, the memory 16 and the processor 18 can be a microprocessor. The non-transitory memory (e.g., memory 16) can be any non-transitory medium that can contain or store the computer program instructions, including, but not limited to, a portable computer diskette; a random-access memory; a read-only memory; an erasable programmable read-only memory (or Flash memory); and a portable compact disc read-only memory). The processor 18 can be a processor of a general-purpose computer, a special purpose computer, and/or other programmable data processing apparatus.

The controller 14, via memory 16, can store one or more subject specific profiles mapping each of a plurality of intended gestures with a specific control signal that can cause a predetermined action of the controllable device 12 and instructions for decoding the intended gestures. It should be noted that intended gesture refers to the neural activity patterns previously determined to be predictive of a user attempting to perform (or performing) a given gesture, which can be a single posture, a combination of postures, a single gesture, and/or a combination of gestures. It should be understood that the intended gestures may in fact be completed physically by the subject but may be only mental, as the controller 12 decodes the neural signals generated in the subject's brain by the intention, not the visual movement, the muscular activation or the like. The subject specific profiles can be determined and calibrated for each individual user and/or based on the controllable device 12 to be controlled (e.g., the control can be different for a computer and a soft robotic glove).

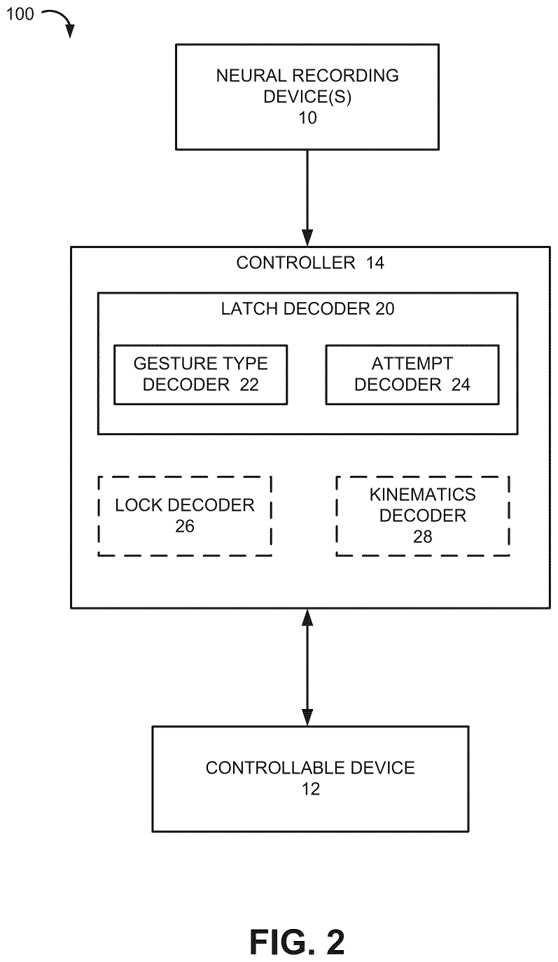

FIG. 2 shows additional aspects of the system 100, particularly details of the decoders that can be executed on/by the controller 14 via the memory 16 and the processor 18, not shown in FIG. 2 for ease of illustration only). Each of the decoders can determine at least one control signal (e.g., command) for the controllable device 12 based on the received neural signals from the neural recording device(s) 10. Each of the decoders can be saved as instructions on the memory and executed by the processor. The controller 14 can include at least a Latch decoder 20 that can determine whether an action should be performed (e.g., by the controllable device 12) and a period of time that action should be held (e.g., duration). The Latch decoder 20 can include a Gesture Type decoder 22 and an Attempt decoder 24 that can run in series and/or parallel with each other. In some instances, the controller 14 can also include a Lock decoder 26 and/or a Kinematics decoder 28 that can run separately from, in parallel with and/or in series with at least a portion of the Latch decoder 20. It should be understood that the decoder names are intended to differentiate the different decoders for ease of illustration and that any decoder with a similar function to that described herein is considered to be covered regardless of naming convention. It should further be understood that the decoders use predictive classification of extracted and analyzed neural signals (e.g., in the form of neural activity patterns) to predict the mostly likely thought of the user and these predictions are considered to be determinations herein.

The Latch decoder 20 can determine whether an action should be performed (e.g., by the controllable device 12) and a period of time that action should be held (e.g., duration). More specifically, the Latch decoder 20 can determine an action to be performed and then output one or more control signals to be sent to the controllable device 12 depending on the input neural signals. The period of time the action should be held can be determined over multiple iterations of the Latch decoder 20 decoding the neural signals. The output of the Latch decoder 20 can depend on the output of the Gesture Type decoder 22 and/or the Attempt decoder 24, as well as the previous state of the Latch decoder output. Based on the output(s) of the Latch decoder 20 the controller 14 can control the controllable device 12 to perform the action for the period of time (e.g., if the Latch decoder determines the action should be performed and then the time period of the performance) or control the controllable device to remain in a waiting state and/or a previous state (e.g., if the Latch decoder determines the action should not be performed).

The Gesture Type decoder 22 can determine whether a known gesture of the plurality of known gestures (e.g., the mapped intended gestures saved in the memory) is being thought and what that known gesture is. For instance, the plurality of known gestures can include an okay sign, a power grip (e.g., a fist), a pinch grip, an open palm, or the like. If the Gesture Type decoder 22 decodes none of these known gestures, then nothing happens and/or a null output/command can be output. If the Gesture Type decoder 22 decodes one of the known gestures, then based on the saved map the control signal for the action associated with the decoded known gesture can be output to the controllable device 12. The type of known gesture can also be fed into the latch output in combination with the attempt decoder 24 to determine if that action should be latched for a time period or only sustained for a finite time (e.g., change with the next different Gesture Type decode).

The Attempt decoder 24 can determine whether a user is intending to sustain any gesture at a given time (e.g., a binary answer, like a Yes attempt state or a No attempt state). It should be noted that the Attempt decoder 24 does not sort types of intended gestures, and only decodes if any of the known gestures in the saved map are being thought by the user. Without wishing to be bound by theory, this can be because as a thought of a gesture is sustained the neural activity pattern degrades and it can become difficult and/or impossible to decode differences between the neural activity patterns for different gestures with the decoders described herein. When the Gesture Type decoder 22 decodes a known gesture, then the Attempt decoder 24 can output a Yes attempt state at the same time. If for one or more intervals thereafter the Attempt decoder 24 continues to output a Yes attempt state, then the Latch decoder 20 can output the latched command (e.g., for the controllable device to sustain an action) until the attempt state changes to no at a later time, then the control signal can be stopped and/or an unlatch command can be output by the Latch decoder 20.

The Lock decoder 26 can determine whether a given control signal should be locked for a sustained time—for example, for an extended time period (e.g., 1 second or longer, 2 seconds or longer, 3 seconds or longer, 5 seconds or longer, 10 seconds or longer, 30 seconds or longer, a minute or longer, or the like) or not. The Lock decoder 26 can, in some instances, be activated a given amount of time after a Latched output command has been held, but before the decoding of the Latch decoder 20 may become inaccurate due to signal decay. One a locked control signal has been output the Lock decoder 26 can then determine whether an unlock control signal should be sent (e.g., based on the decoding of a specific intended gesture mapped to an unlock command). The Lock decoder 26 facilitates the user's ability to intuitively multitask and/or perform complex multi-action functions (e.g., with the same controllable device 12 and/or switching between two or more controllable devices).

The Kinematics decoder 28 can decode gestures that are kinematic movements (e.g., three dimensional movements of a finger, wrist, hand, arm, etc. that can be mapped to a 2D movement of a cursor or a 2D or 3D movement of a robotic end effector) using a Kalman Filter based decoder. The Kinematic decoder 28 can run in parallel with the Latch decoder 20 and/or the Lock decoder 26 to facilitate the user controlling the controllable device 12 to perform a held action and then a move action while the held action is sustained. For instance, the user can perform a drag and drop function on a computer (e.g., click and hold and then move an object to a new location on the user interface), move an object and/or tool held by a robotic end effector, prosthetic limb including a hand, and/or a hand wearing a soft robotic wearable, or the like.

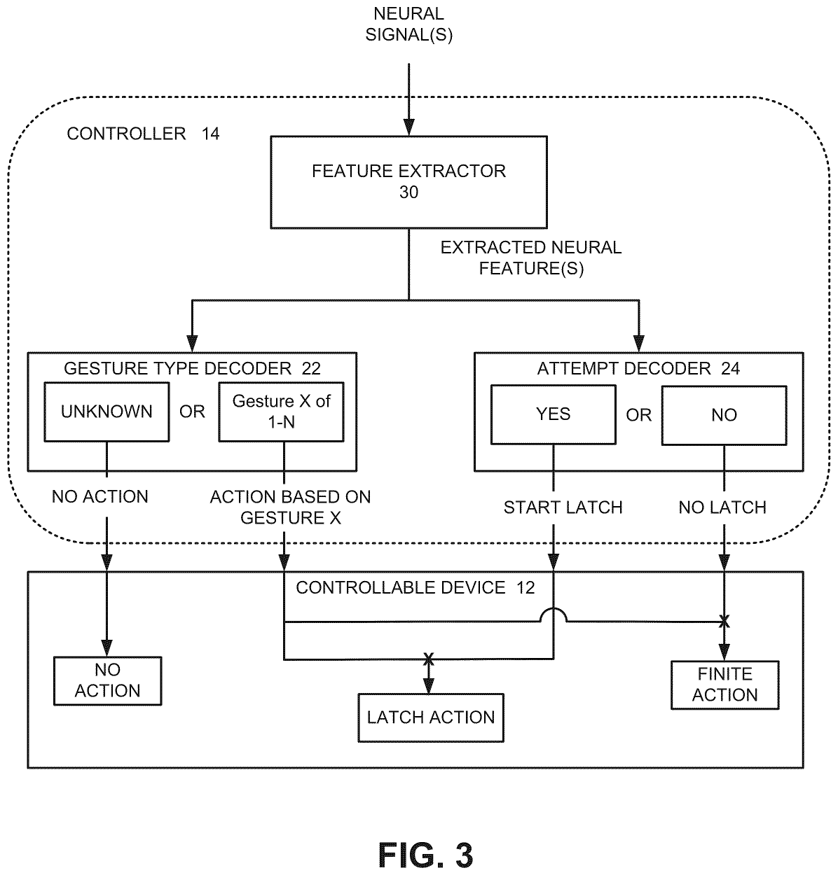

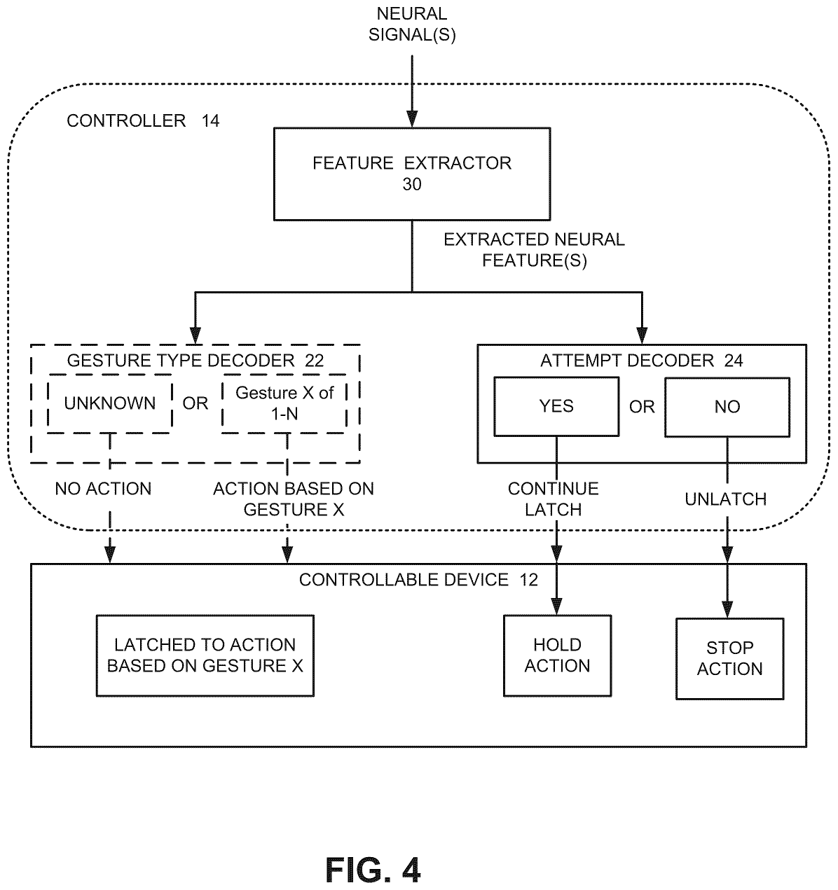

FIGS. 3 and 4 show a portion of the system 100 focused on the Gesture Type decoder 22 and the Attempt decoder 24 functionalities in greater detail. The controller 14 can receive the neural signal(s) (e.g., from the neural recording device(s) 10) at a given time. The controller 14 can extract at least one neural feature from the at least one neural signal of the user with feature extractor 30. From each neural signal the extracted neural features can include, but are not limited to, threshold crossings, spike band power from between the 250 Hz-5,000 Hz band (e.g., using an 8th order HR Butterworth filter), and local field potential power across five bands (e.g., 0 Hz-11 Hz, 12 Hz-19 Hz, 20 Hz-38 Hz, 39 Hz to 128 Hz, and 129 Hz-150 Hz) (e.g., using short-time Fourier transforms). A neural activity pattern for a time can be formed based on the combination of extracted neural features for each of the neural signals recorded. The extracted neural features (e.g., the neural activity pattern) can then be input into the Latch decoder-shown as the sub-decoders Gesture Type decoder 22 and Attempt decoder 24 in this figure for ease of illustration and discussion. It should be noted that the Gesture Type decoder 22 and the Attempt decoder 24 can be executed in series, in parallel, at least partially concurrently, and/or on a predetermined lag.

The Gesture Type decoder 22 can determine whether the user is thinking of attempting to perform a known gesture (e.g., Gesture X) of a plurality of known gestures (e.g., Gestures 1-N). The Gesture Type decoder 22 can also determine why known gesture of the plurality of known gestures the user is thinking of attempting to perform. The results of the Gesture Type decoder 22 can be known gesture X out of known gestures 1-N or unknown gesture. If the Gesture Type decoder 22 decodes for an unknown gesture result, then the controller 14 can either output no action and/or a null output that can result in either no action and/or a controllable device 12 returning to a waiting state. If the Gesture Type decoder 22 decodes a known gesture than the control signal mapped to that known gesture can be sent to the controllable device 12 to perform the action. As shown in FIG. 3, the action can be a finite action and/or a latched action (e.g., a sustained action) depending on the output from the Attempt decoder 24 and a timing aspect (described below). The Attempt decoder 24 can determine whether the user is thinking of attempting to perform any known gesture of the plurality of known gestures (e.g., only determines known or unknown). The Attempt decoder 34 can output a Yes attempt state if an attempt is determined (e.g., any known gesture is being attempted at a time) and a No attempt state if no attempt is determined (e.g., none of the known gestures are being attempted at the time).

If no gesture type has been latched in the Latch decoder (e.g., Latch decoder 20), then, as shown in FIG. 3, the Attempt decoder 24 can either output a control signal that indicates start a latch (if Yes attempt state determined) or no latch (if No attempt state is determined) at a given time. The attempt state determination may occur at a same time as a gesture type determination, at a time lagged behind the gesture type determination, and/or over a time period concurrent with but longer than the gesture type determination (e.g., the attempt must be held for X time longer to make an attempt determination than needed to make a gesture type determination). If the gesture type determination occurs before the attempt determination, then a control signal can be sent to the controllable device 12 to perform a finite action. The control signal can have the option to be elongated to a latched action (e.g., a sustained action) if a positive attempt determination is then made. If the gesture type determination outputs a control signal and the attempt determination outputs a latch control signal concurrently, then a directly latched action control signal can be sent to the controllable device 12. For example, if a power grip is decoded starting at t=0 ms and a Yes Attempt is decoded starting at t=300 ms onward, the system can latch at t=400 ms. In another example, if power grip decoding started at Oms and continued until t=400 ms and a Yes Attempt was not decoded until 500 ms (e.g. if the Attempt decoder 24 was configured to lag more than the Gesture Type decoder 22), then the latch would not occur until 500 ms, when both conditions were true (power grip was decoded for 400 ms AND Attempt Decoder decoded Yes).

If a gesture type has been previously latched in the Latch decoder (e.g., Latch decoder 20) (e.g., controllable device is latched to an action based on the originally latched gesture type) then, as shown in FIG. 4 (by the dashed lines) the continued gesture type decoding can be ignored by the Latch decoder and the Attempt decoder 24 can decode until an attempt is no longer determined. The yes attempt state from the Attempt decoder 24 can then be determined by the controller 14 to indicate continue sending the control signal to sustain the action. The no attempt state from the Attempt decoder 34 can cause the controller 14 to end the previously latched control signal and/or send an unlatch control signal to stop the action of the controllable device.

The Gesture Type decoder 22 and/or the Attempt decoder 24 can be a discrete classifier. For instance, the Gesture Type decoder 22 can be a linear discriminant analysis (LDA) in conjunction with a Hidden Markov Model (HMM) (LAD-HMM) trained to differentiation between a plurality of known gestures and a relax state (each identified as a class). And the Attempt decoder 24 can be an LDA-HMM trained to differentiate between only known and unknown. As a specific and non-limiting example, the extracted features can be smoothed with a box car filter and can be projected into a low dimensional space before class posterior probabilities can be determined using the LDA. Within the LDA a regularization parameter can be set to a number between 0 and 1 and used to compute the LDA coefficients and class means and covariances can be determined using empirical means and covariances saved from calibration data. Emission probabilities can be produced by the HMM, smother again with a filter, and thresholded to determine the decoded state output for each decoder. For the Gesture Type decoder 22 the HMM transition matrix can be set to match the gesture state transitions of a previously performed calibration task. For the Attempt decoder 24 the HMM transition matrix can be set to an “extra sticky” state (e.g., with on diagonal values of Jan. 10, 2010) to prevent transient misclassification of the attempt signal. Of the recorded extracted features after the LDA-HMM has been performed a given number of the top recorded features can be selected for classification analysis by identifying all gesture or attempt selective features (e.g., using a Kruskal Wallis test). The top plurality of features can be ranked according to a minimum redundancy maximum relevance algorithm to determine optimal feature selection for each decoder individually (e.g., determinations by Gesture Type decoder 22 and/or Attempt decoder 24).

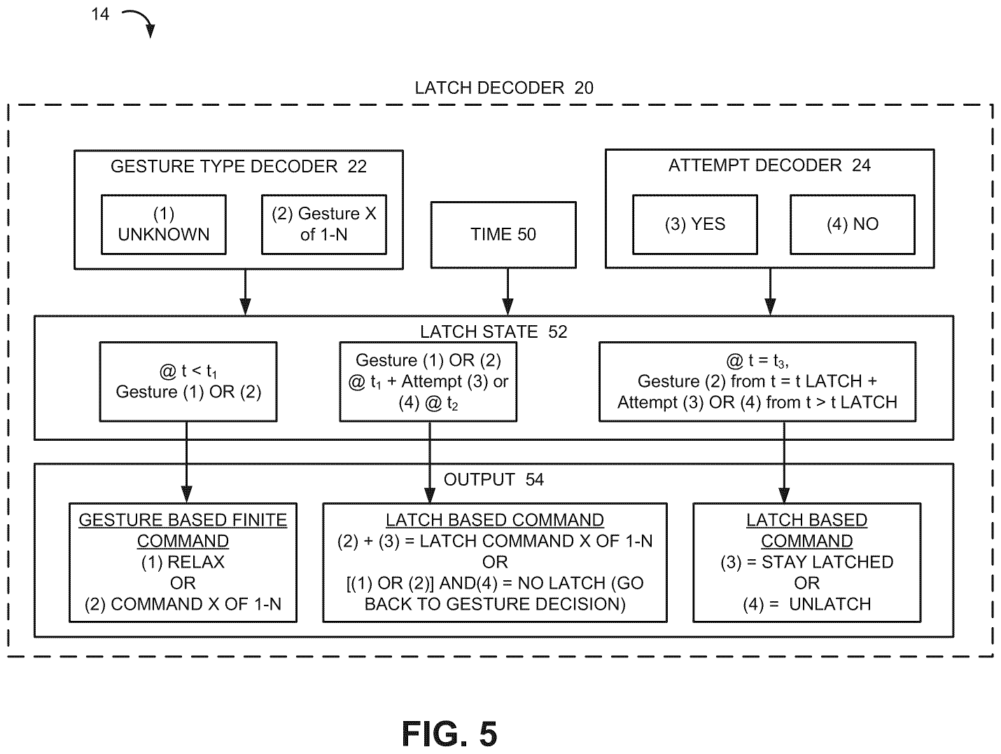

FIG. 5 illustrates the Latch decoder 20, including the Gesture Type decoder 22 and the Attempt Decoder 24, as executed by the controller 14 in additional detail. As previously discussed, the Gesture Type Decoder 22 can output either (1) an unknown state or (2) which known gesture (Gesture X) of the plurality of known gestures (Gestures 1-N) was determined. Also as previously discussed, the Attempt decoder 24 can output either a (3) Yes attempt state or a (4) No attempt state determination. How the Latch decoder 20 uses and understands these outputs to form Latch States 52 and that Latch Outputs 54 can be further based on time 50. The logic of the Latch Decoder can determine whether the Gesture Type decoder 22 output should directly pass through at a given time or whether a saved previous output should be used. For instance, if the time 50 is less than a first time only the Gesture Type Decoder 22 can be executed so the Latch State 52 can be either (1) unknown gesture or (2) one of the known gestures of the plurality of known gestures (Gesture X of 1-N). The if the Latch State 52 is (1) unknown then the Latch Output 54 can be a control signal for that indicates no action should be taken and/or that can control the controllable device (e.g., controllable device 12) to return to a waiting (e.g., relax) state. If the Latch State 52 is (2) a known gesture of the plurality of known gestures (Gesture X of 1-N) then the Latch Output 54 can be a control signal that can control the controllable device to perform a finite action associated with the known gesture (e.g., gesture based finite command X of 1-N).

In another instance, if the time 50 is a second time then the Latch State 52 can be based on if the Gesture Type decoder 22 decoded either (1) the unknown gesture or (2) the known gesture of the plurality of known gestures (Gesture X of 1-N) at a first time (less than or equal to the second time) and if the Attempt Decoder decoded a Yes attempt state or a No attempt state at the second time (which can be the same or greater than the first time). If the Latch State 52 is (2) the known gesture of the plurality of known gestures (Gesture X of 1-N) at the first time and (3) the Yes attempt state at the second time then the Latch Output 54 can be a control signal that can control the controllable device to perform a sustained action associated with the known gesture (e.g., latch command X of 1-N). Put another way, the Latch Output 54 can be a latch on the action command (e.g., to cause the controllable device to hold the action) if the type of known gesture can be determined for the first time and a Yes attempt state can be determined for a second time. If the Latch State 52 is (2) the known gesture of the plurality of known gestures (Gesture X of 1-N) at the first time and (4) the No attempt state at the second time, then the Latch Output 54 can be the finite command without any latching. If the Gesture Type decoder 22 was executed and (1) unknown was decoded at the first time, then the controllable device can be controlled (or not controlled) to remain in a waiting (relax) state and/or the previous state regardless of the decoded attempt state. In some instance the first time and the second time can be the same time (e.g., no lag between the Gesture Type decoder 22 and the Attempt decoder 24). In other instances, the first time and the second time can be different, with the second time being longer than the first time (e.g., the Attempt decoder 24 can lag behind the Gesture Type decoder 22).

In the circumstance where the Latch decoder has previously output a latched action command and the controller 14 has sent a control signal/command to the controllable device, then at a third time (after the latched action has already started) the Latch State 52 and the Latch Output 54 can be determined based on the output of the Attempt decoder—(3) Yes attempt state or (4) No attempt state. If the Latch State 52 is based on (3) Yes attempt state, then the latched action of the controllable device (based on (2)) can be controlled to continue. The Latch Output 54 can be a stay latched at the action command and/or another iteration of the latching command that can control the controllable device to hold the action at the third time. This can be repeated until the Latch Output 54 is an unlatch command/or the latch command stops being sent. If the Latch State 52 is based on (4) No attempt state, then the latched action of the controllable device (based on (2)) can be controlled to end. The Latch Output 54 can be an unlatch command and/or a cessation of a continue to latch command, which can control the controllable device to stop the action.

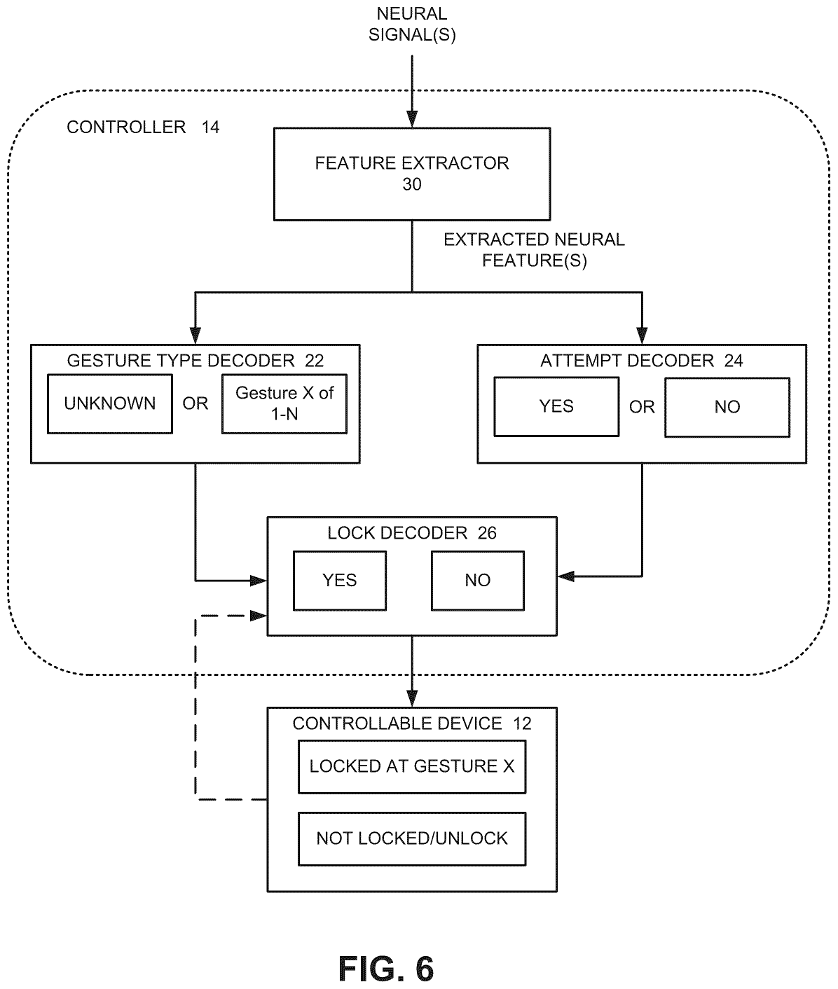

FIG. 6 shows a further portion of the system 100 with detail focused on Lock decoder 26 in addition to the Gesture Type decoder 22 and the Attempt decoder 24. The controller 14 can execute the Lock decoder 26 based on the output of the Latch decoder 20 (e.g., the combination of the outputs of the Gesture Type decoder 22 and the Attempt decoder 24 as shown). The Lock decoder 26 can lock the controllable device 12 (e.g., via a control signal) to perform the action (based on the intended gesture) for an extended period of time, longer than the period of time of the Latch controller 20, until an unlock gesture is decoded by the Latch decoder and fed to the Lock decoder. The Lock decoder 26 can lock the controllable device 12 to perform the action for the extended period of time if the period of time the action is performed under the latched command reaches a predetermined lock time (e.g., a fourth time, that can be any time beyond what the Latch decoder 20 an accurately decode for). In some instance the Lock decoder 26 can determine if a lock can be placed on the controllable device 12 to perform the action for the extended period of time based on physical feedback from the controllable device. For instance, the physical feedback can include one or more sensor information, including but not limited to one or more position, acceleration, velocity, orientation, joint angle, and/or force acting upon at least a portion of the controllable device 12 (e.g., that includes and/or has one or more sensors positioned thereon). The Lock decoder 26 can determine the action should be unlocked when a specific predetermined known gesture is decoded by the Gesture Type decoder. Then an unlock control signal and/or a cessation of the locking control signal can be sent to the control device 12 to unlock (e.g., end) the action. It should be noted that until a lock is placed the lock decoder 26 assumed output can be no output and/or a no lock output.

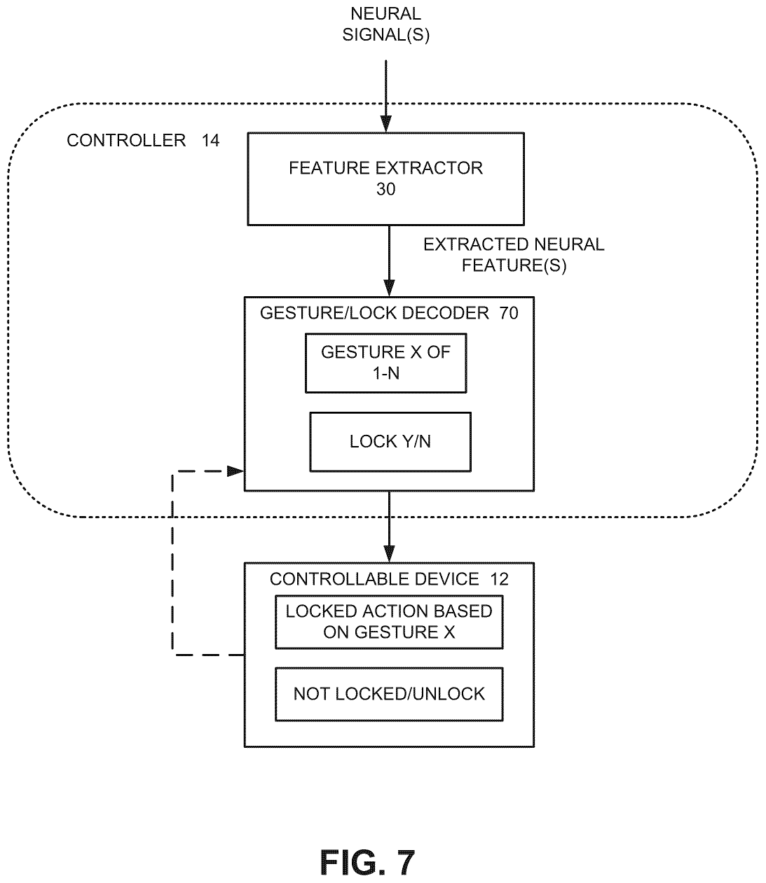

FIG. 7 shows an alternative embodiment of system 100 where no latch decoder is required, and the lock controller can be combined with the gesture type decoder to form a Gesture/Lock Decoder 70. Similar to previously described the controller 14 can receive the neural signal(s) and extract neural feature(s) via feature extractor 30. The extracted neural feature(s) can be input in the combination Gesture/Lock decoder 70. The combination Gesture/Lock decoder 70 can determine whether the extracted neural feature(s) predict a known gesture of a plurality of known gestures (Gesture X of 1-N) was at least thought to be performed, what the known gesture was (and the associated/mapped control signal) and whether or not a lock should be placed on the control signal for the known gesture at a given time. The lock can be based on a length of time the known gesture has been repetitively decoded and/or feedback from the controllable device 12.

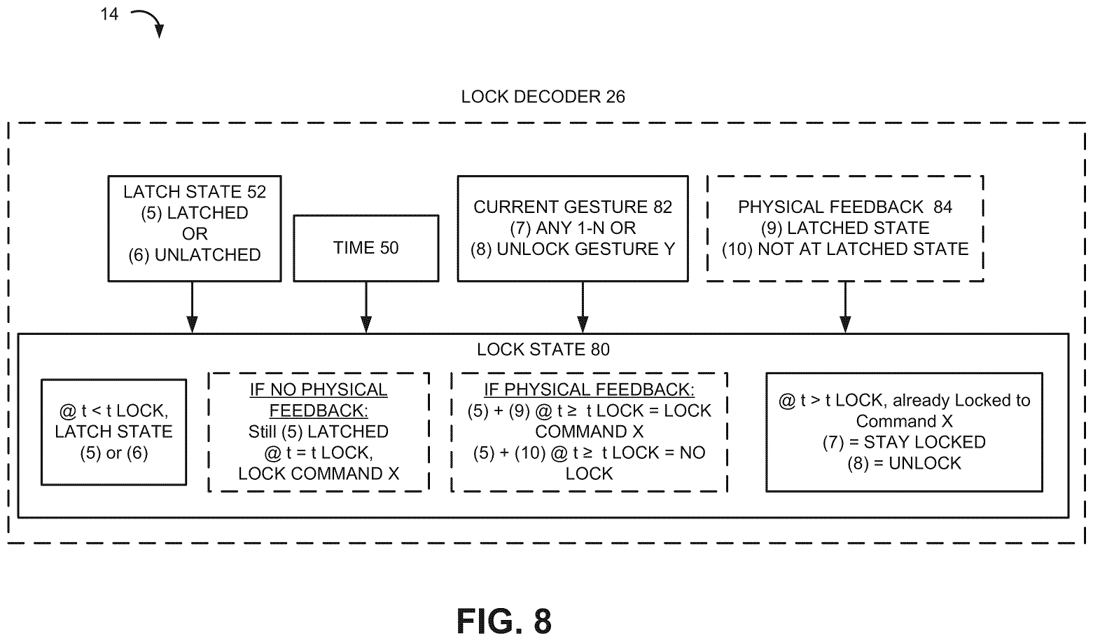

FIG. 8 illustrates the Lock decoder 26, as executed by the controller 14 in additional detail. The Lock decoder 26 can include as inputs the Latch State 52, time 50, a currently decoded Gesture type 82, and, optionally, physical feedback 84 from the controllable device (e.g., controllable device 12). At time 50 is less than a predetermined lock time (e.g., the fourth time), then the lock state 80 is unlocked and based on the latch state 52 (5) latched or (6) unlatched. If the system 100 does not include physical feedback 84 from the controllable device (e.g., controllable device 12), then at the predetermined lock time (e.g., the fourth time), and the latched state 52 is (5) latched then the control signal based on the latched action command (e.g., associated with the latched gesture) can be locked (e.g., lock command X, the command associated with the gesture X). If the system 100 does include physical feedback 84 from the controllable device (e.g., controllable device 12) then the Lock state 80 can be based on both the Latch State 52 at the predetermined lock time or later and the physical feedback 84. If the Latch State 52 is (5) Latched and the physical feedback 84 indicates (9) the latched action is being performed, then the control signal can be locked. If the physical feedback 84 indicates the latched action is not being performed, then the lock state 80 (and the control signal) can not be locked even if the Latch State 52 indicates (5) Latched. The lock state 80 can be determined at a next time point to see if the action is being performed properly (e.g., the controllable device 12 can lag behind the control signals in some instances). If the Latch State 52 is (6) unlatched then there is no lock and/or no lock determination (e.g., lock decoder can not activate till there is a latched state in some instance) regardless of the optional physical feedback.

If the time 50 is some time greater than the lock time and the Lock State 80 is already locked (e.g., the action of the controllable device 12 is locked), then the lock decoder 26 can determine whether to stay locked or unlock. The lock decoder 26 can be configured to not unlock until the current gesture 82 is a specific (8) unlock gesture (e.g., gesture Y) decoded by the Gesture Type decoder (e.g., Gesture Type decoder 22). Thus, if the current gesture 82 is (7) any other gesture (e.g., gestures 1-N other than Y) then lock can remain in place. In this manner the system 100 can decode at least one other intended gesture while the locked action is held to perform multi-tasking and/or multi-combination actions (such as drag and drop, hold and move an object, or the like).

In some instances, the kinematic decoder (e.g., kinematic decoder 28) can be executed to combine a sustained action with one or more movement-based actions. For example, the controllable device (e.g., controllable device 12) can be a soft robotic glove, which can include a plurality of actuators and pressure sensors, that can be capable of producing at least four hand postures (for finite or sustained times)—(1) a power grip (e.g., all fingers flexed in a fist), (2) a pinch grip (e.g., only index and thumb flexed towards each other), (3) an open hand (e.g., all fingers extended), and (4) a relaxed or no action state (e.g., all fingers relaxed and all actuators off/deflated). The soft robotic glove can begin to flex all the fingers to form a power grip, a pinch grip, or an open hand when the Gesture Type decoder 22 determines the incoming neural signals are sufficiently similar to the stored “template” of neural signals for a power grip, a pinch grip, or an open hand, respectively. If the Gesture Type decoder 22 does not have a sufficient level of confidence which grip is intended, then the default output is the relax/no action output and the SRG can maintain or return to the relax posture. If the Gesture Type decoder 22 and the Attempt decoder 24 determine one of the power grip, pinch grip, or open hand and a yes Attempt state for a predetermined time (as discussed above) the Lock decoder 26 can engage a lock on that grip. Then, for example, if the user is also using an at least partial soft robotic arm sleeve or the like that can perform directional movement, directional movement could be enabled if the Kinematic decoder (e.g., Kinematic decoder 28) decoded neural signals indicating a direction movement. Thus, an object griped and/or pinched by the hand could be moved in time and space while the grip and/or pinch is locked. To place the object in a new location the Lock decoder 28 can decode neural signals indicating a specific unlock gesture and an unlock command and/or a cessation of the lock command can be sent to soft robotic glove and the object can be released when the soft robotic glove returns to a relaxed state. It should be understood that this is only a single example and many more examples with other controllable devices (e.g., computer functions, manufacturing robotics, exoskeletons, FES system, etc.) and/or specific postures and/or movements are considered.

### IV. Methods

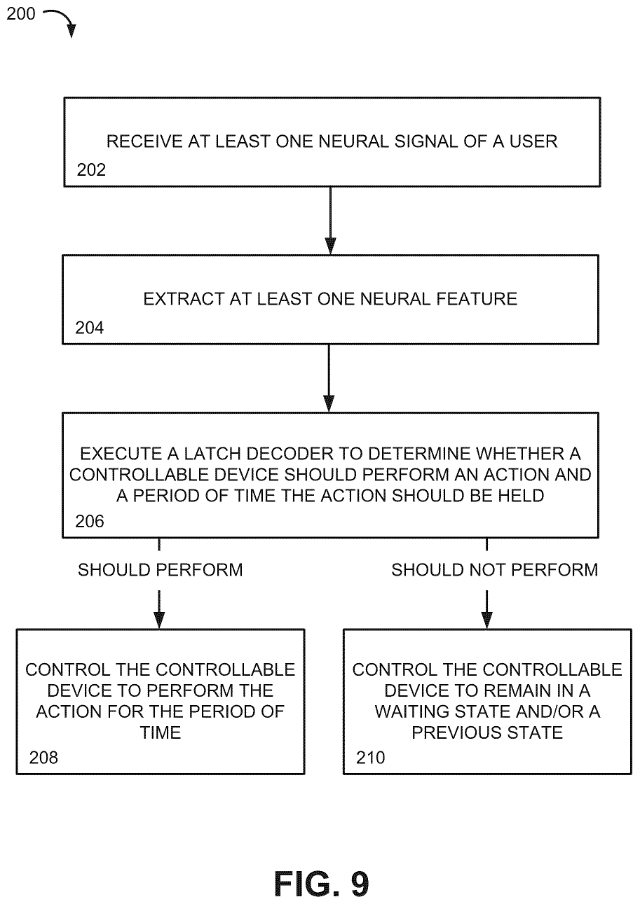

Another aspect of the present disclosure can include methods 200, 300, 400, and 500 (FIGS. 9, 10, 11, and 12) for using a BMI to decode thoughts of performing or attempting to perform sustained gestures for mentally controlling sustained duration (e.g., held) actions of a controllable device. The BMI can be embodied on any system comprising at least a processor and a memory (e.g., controller 14 including memory 16 and processor 18) and the controllable device can be any device and/or system that can receive a control signal via wired and/or wireless means (e.g., controllable device 12). The controllable device can be, for instance, a processor connected with a visual display (e.g., computer, tablet, smartphone, or the like that would traditionally have keyboard, mouse, and/or touch screen based control), a robot configured to perform at least one task, an exoskeleton configured to be worn on at least one body part of the user to move the at least one body part, a robotic limb representing at least a portion of a limb of the user, a smart appliance (such as a smart thermostat, oven, refrigerator, lights, or the like), at least one electrode configured to provide at least one functional electrical stimulation (FES) to the user to cause a muscle contraction, or the like. At least one function of the controllable device can be performed in a finite and/or sustained manner when traditionally commanded. For example, a computer can have functions based on an individual click at a location, a sustained click at a location, a sustained scroll or swipe, or a click, drag and drop (e.g., moving a file). In another example the length of time of a grip or a force application from a robotic end effector can be controlled with finite and/or sustained controls.

The methods 200, 300, 400, and 500 can be executed using the system 100 shown in FIGS. 1-8. For purposes of simplicity, the methods 200, 300, 400, and 500 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 200, 300, 400, and 500, nor are methods 200, 300, 400, and 500 limited to the illustrated aspects.

FIG. 9 shows a general method 200 for sing a BMI to decode thoughts of attempting to perform sustained gestures for mentally controlling sustained duration (e.g., held) actions of a controllable device. At 202, at least one neural signal of a user can be received by a system (e.g., system 100), which can include at least a processor and a memory, from at least one neural recording device associated with the user. The at least one neural recording device can include at least one electrode that can by transcutaneous, percutaneously, and or subcutaneously positioned and can record electrical signals from the user's nervous system (e.g., the user's brain). For instance, the at least one neural recording device can include at least one intracortical implanted micro-electrode array comprising a plurality of channels, where each channel can record a different neural signal. The at least one neural recording device can be, for instance, implanted in and/or positioned over a portion of one of the user's precentral gyri (e.g., left or right). It should be understood, however, that the electrodes can record from other parts of the brain/spinal cord and/or other parts of the body (e.g., peripheral nervous system).

At 204, at least one neural feature can be extract from each of the at least one neural signals. For instance, the extracted neural features from each neural signal can include, but are not limited to, threshold crossings, spike band power from between the 250 Hz-5,000 Hz band (e.g., using an 8th order HR Butterworth filter), and local field potential power across five bands (0 Hz-11 Hz, 12 Hz-19 Hz, 20 Hz-38 Hz, 39 Hz to 128 Hz, and 129 Hz-150 Hz) (e.g., using short-time Fourier transforms). A neural activity pattern for a time can be formed based on the combination of extracted neural features for each of the neural signals recorded. The extracted neural features (e.g., the neural activity pattern) can then be input into a Latch decoder (e.g., Latch decoder 20). At 206, a Latch decoder can be executed to determine whether a controllable device should perform an action and/or a period of time the action should be held. The Latch decoder can include a Gesture Type decoder (e.g., Gesture Type decoder 22) and an Attempt decoder (e.g., Attempt decoder 24) that can be executed in parallel, in series, and/or with the Attempt decoder at a lag behind the Gesture Type decoder.

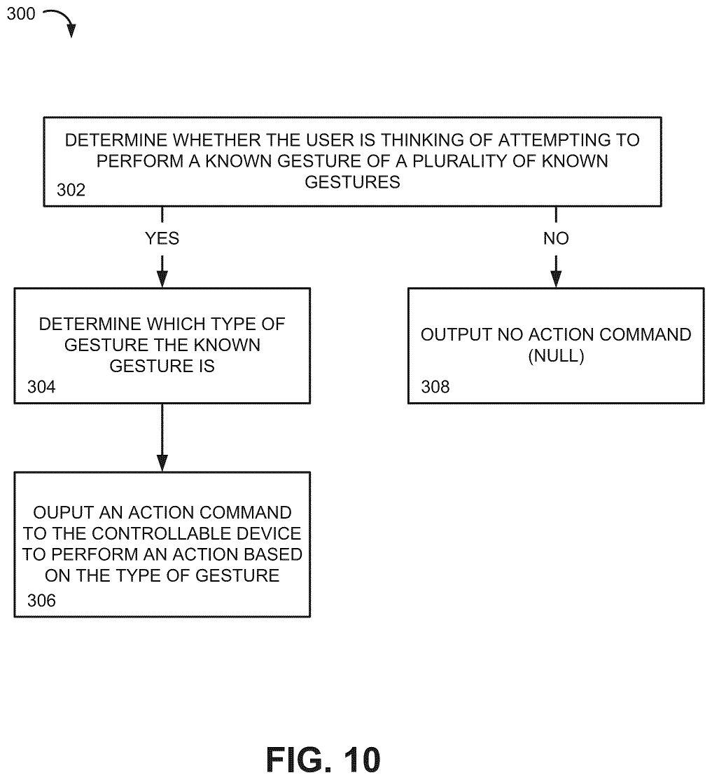

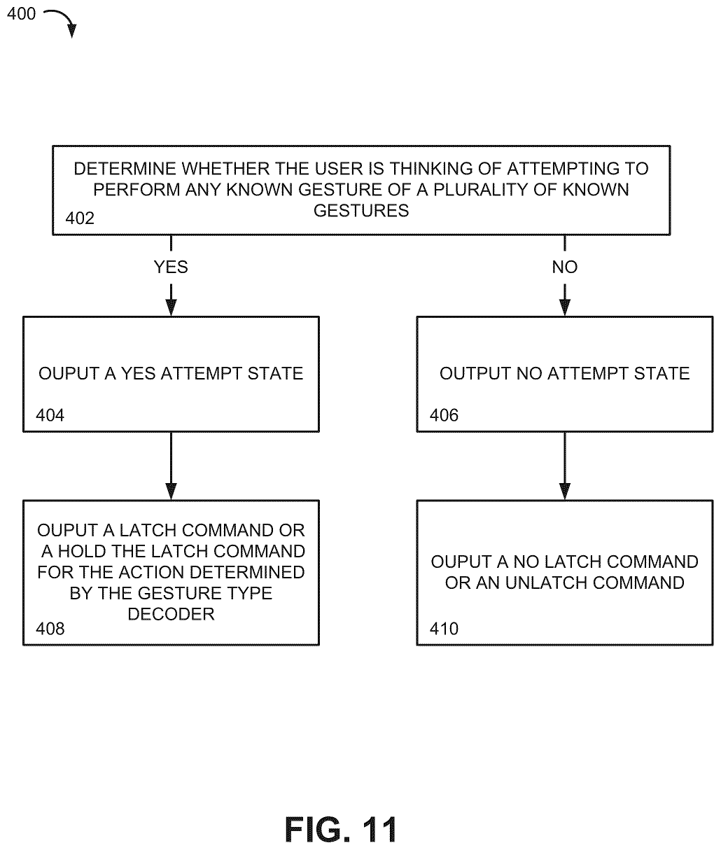

The Latch decoder can determine that an action should or should not be performed based on the output of the Gesture Type decoder (described in further detail below with respect to FIG. 10). If the action should be performed the Gesture Type decoder can determine which action should be performed. At least one map associating each of the neural activity patterns of a plurality of intended known gestures with a predetermined control signal for a controllable device to perform a predetermined action can be stored in a memory of the system. The Gesture Type decoder can determine if a current neural activity pattern is one of the known neural activity patterns, or a neural activity pattern similar enough (e.g., based on a confidence level) to one of the known neural activity patterns and can output the associated control signal for the controllable device to perform the action. If the current neural activity pattern is determined to be similar enough to a known neural activity pattern, then at 208 the controllable device can be controlled to perform the action mapped to the known neural activity pattern. The period of time the action can be held for can be based on an output from the Attempt decoder (e.g., Attempt decoder 24) over multiple time points (as described in further detail below with respect to FIG. 11). If the current neural activity pattern is determined to not be similar enough to a known neural activity pattern, then at 210 the controllable device can be controlled to remain in a waiting/relaxed state and/or previous state and not perform a new action.

The output from the system based on the Latch decoder outcome can include sending an action command to the controllable device for a finite time if the type of known gesture is determined for less than a first time (e.g., before an Attempt decoder determination can be made), a latch on the action command to the controllable device if the type of known gesture is determined for the first time and a Yes attempt state is determined for a second time (at which the Attempt decoder time can be made), wherein the latch causes the controllable device to hold the action; or a no action command to the controllable device if no known gesture type is determined. If a latch command was previously output by the system, then the output from the system can include sending a hold the action command (or simply continuing the previous control signal) if the Yes attempt state is determined at a third time after the second time, wherein the controllable device holds the action at the third time, or an unlatch command if the No attempt state is determined at the third time after the second time, wherein the unlatch command controls the controllable device to stop the action.

FIG. 10 shows the method 300 performed by the Gesture Type decoder within the Latch decoder discussed above with respect to FIG. 9. At 302, whether the user is thinking of attempting to perform a known gesture of a plurality of known gestures (e.g., stored in memory and each mapped to a control signal for the controllable device) can be determined based on the received neural activity patterns (e.g., the extracted neural features for each of the neural signals received by the processor). If the User is thinking of attempt to perform a known gesture (e.g., Yes), then at 304, which type of gesture the known gesture can be determined based on comparing the current neural activity pattern with the stored neural activity patterns. The Gesture Type decoder can be, for instance, a discrete classifier such as an LDA-HMM classifier with each known gesture (e.g., the neural activity pattern) as a class. If the current neural activity pattern is determined to be similar enough (e.g., based on discrete classification) to a known activity pattern, then at 306, the control signal (e.g. a command) mapped to the indicated known gesture though can be output to the controllable device to perform the action based on the type of gesture. The action can be finite or sustained depending on the decoding of the Attempt decoder and the logic of the Latch decoder. The output control signal can be saved in memory to determine if the Attempt decoder will indicate the Latch logic should latch the control signal for a sustained action or not. Alternatively, if, the current neural activity patterns are not similar enough to a known neural activity pattern (e.g., the user is not intending a known gesture), then the determination of the Gesture Type decoder can be NO. At 308, no action can be output and/or a null command indicative of the controllable device either relaxing or remaining in a previous state (depending on the type of controllable device—e.g., a robot or soft robotic glove could relax, a cursor could stay at a previous position on a display, or the like) can be output to the controllable device.

FIG. 11 shows the method 400 performed by the Attempt decoder within the Latch decoder discussed above with respect to FIG. 9. The output of the Attempt decoder can determine if an action of the controllable device (e.g., a control signal causing the action to happen) should be latched and if a latch should hold for a time or unlatch. At 402, whether the user is thinking of attempting to perform any known gesture of the plurality of known gestures (e.g., the neural activity patterns saved in memory) can be determined. The Attempt decoder can be, for instance, a discrete classifier such as an LDA-HMM classifier with two classes-one containing all the known neural activity patterns and the other for all unknown neural activity patterns. The Attempt decoder can determine if yes, an attempt is being made, then at 404 can output a Yes attempt state, or if no, an attempt is not being made, then at 406 can output a No attempt state. The outcomes from the Yes and No attempt states being output can be determined based on at least the logic of the Latch controller, a previous state of the Latch decoder output, and/or time.

At 408, a command to latch a control signal already determined by the Gesture Type decoder determination can be output if no latch is already in place. The latch can apply to a concurrently decoded control signal based on the Gesture Type decoder's determination and/or a previous determination saved in memory (depending on the logic of the Latch controller). If a latch is already in place, then at 408 a continue or hold the latch command (or a continuation of the latch signal) can be output to keep the action latched until a No attempt state is determined. Thus, the latch decoder can determine the period of time the action should be held based on when the attempt state changes to no. At a No attempt state, the Latch decoder can, at 410, output a no latch command (e.g., if no latch has been started yet) or an unlatch command (or a cessation of a latch command) (e.g., if a latch was already present).

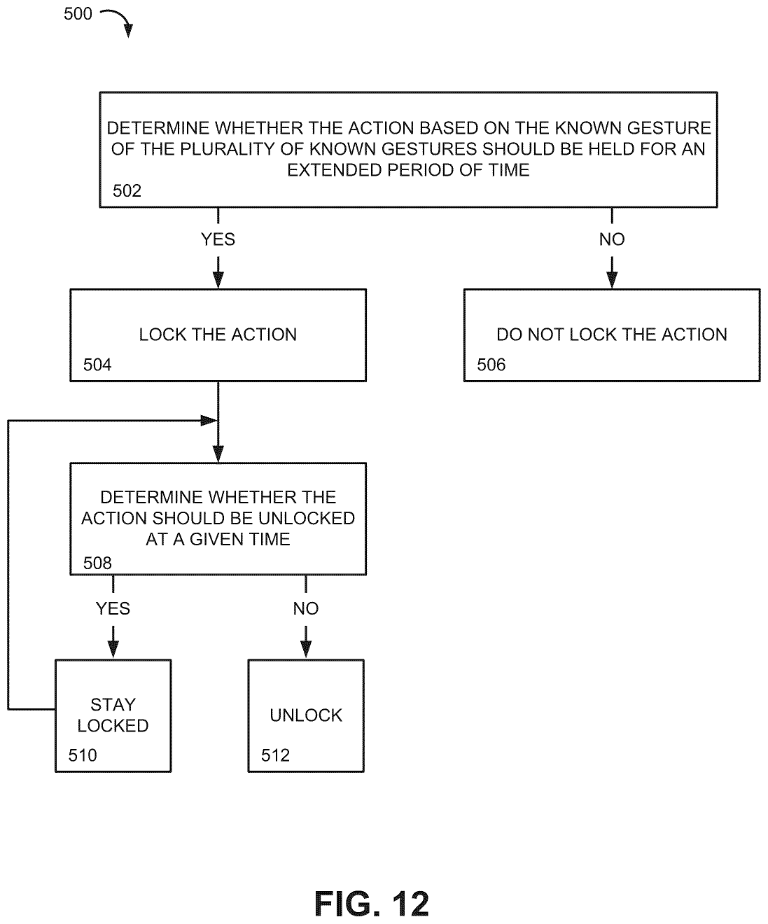

FIG. 12 shows a method 500 where a Lock decoder can further be executed to determine whether and/or how long an action of the controllable device should be locked. For instance, a lock can be used in the case where a user intends an action to be held longer than the Latch decoder can accurately decode and/or if the user intends to multi-task and/or simultaneously perform two actions, with the same controllable device or multiple controllable device). For example, a lock can be used to click and drag a file, to rewind a video or to hold an object for longer than a few seconds, to hold an object and move the object in space, and the like. At 502, determine whether the action being performed by the controllable device based on the known gesture of the plurality of known gestures (e.g., as determined by the Gesture Type decoder) should be held for an extended period of time (e.g., longer than a latch hold can accurately decode). The determination can be based on a time and/or physical feedback from the controllable device. If the determination is Yes, then at 504 the action (e.g., the control signal causing the action) can be locked such that the action is performed until an unlock determination is made. If the determination is No, then at 506 the action is not locked and the method 500 may be re-started. Once the action performed by the controllable device is locked (e.g., the control signal is locked), then the Lock decoder can determine, at 508, whether the action should be unlocked at any given time point. This determination can be based on if a current gesture (e.g., thought of at least an attempt to perform a gesture) decoded by the Gesture Type decoder is a specific predetermined “unlock gesture” (e.g., stored in the map in the memory). If no unlock gesture is decoded at a time, then at 510 the lock stays in place. If the unlock gesture is decoded at a time, then at 512 the action can be unlocked (e.g., via sending an unlock control signal and/or ending the lock control signal).

### V. Experimental

The following experiments present intracortical brain-computer interfaces (iBCIs) that can enable both finite control such as “point and click” actions as well as longer duration “held” or “reach and grasp” actions. The first experiment investigated the use of a novel Latch decoder for longer duration “held” and “reach and grasp” action in the context of controlling a cursor on a visual display (e.g., of a computer). The second experiment investigated the use of the Latch decoder on its own and in combination with a Lock decoder for even longer duration “hold” actions in the context of controlling a soft-robotic glove.

### A. Experiment 1

This experiment investigated the use of a novel Latch decoder for longer duration “held” and “reach and grasp” action in the context of controlling a cursor on a visual display (e.g., of a computer). The performance of multi-class and binary (attempt/no-attempt) classification of neural activity in the left precentral gyrus of two participants performing hand gestures for 1, 2, and 4 seconds in duration was examined. A “latch decoder” was designed that utilizes parallel multi-class and binary decoding processes and evaluated its performance on data from isolated sustained gesture attempts and a multi-gesture drag-and-drop task. The Latch decoder demonstrated substantial improvement in decoding accuracy for gestures performed independently or in conjunction with simultaneous 2D cursor control compared to standard direct decoding methods.

### 1. Methods

### 1.1 Participants

Participants T11 and T5 provided informed consent and were enrolled in the pilot clinical trial of the BrainGate Neural Interface System. T11 is a 39-year-old man with tetraplegia due to a C4 AIS-B spinal cord injury that occurred 11 years prior to enrollment in the trial. T5 was a 70-year-old man with tetraplegia due to a C4 AIS-C spinal cord injury that occurred 9 years prior to enrollment in the trial. At the time of this study, T11 had been enrolled in the trial for approximately 1 year, and T5 had been enrolled in the trial for approximately 6.5 years.

Permissions for this study were granted by the US Food and Drug Administration (FDA, Investigational Device Exemption #G090003) and the Institutional Review Boards (IRBs) of Massachusetts General Hospital (#2009P000505, initially approved May 15, 2009, includes ceded review for Stanford University and Brown University) and Providence VA Medical Center (#2011-009, initially approved Mar. 9, 2011). All research sessions were performed at the participants' place of residence.

1.2 Intracortical Recordings

Data were recorded via two 96-channel microelectrode arrays (Blackrock Neurotech) placed chronically in the hand-knob area of the left precentral gyrus (PCG) of each participant. Neural signals from T11 were transmitted wirelessly using two ‘Brown Wireless’ devices (Blackrock Neurotech), whereas neural signals from T5 were acquired using two NeuroPort Patient Cables (Blackrock Neurotech). Previous work showed a negligible difference in signal quality between these two signal transmission strategies. From these recordings, neural features were extracted that included threshold crossings (TX) [23], spike band power (SP) from the 250-5000 Hz band (8th order IIR Butterworth), and short-time Fourier transform extracted local field potential (LFP) power across five bands, 0-11 Hz, 12-19 Hz, 20-38 Hz, 39-128 Hz, and 129-250 Hz.

### 2. Latch Decoder Development

### 2.1 Multi-Duration Gesture Study: Gesture Hero Task

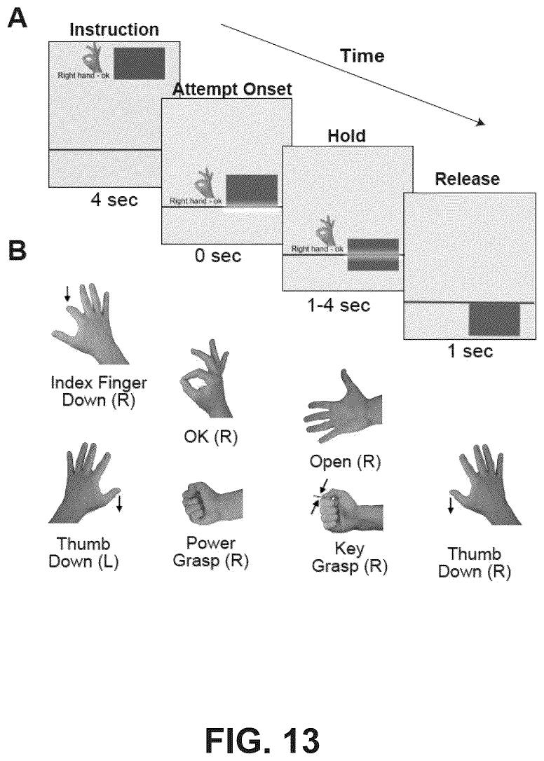

To better understand how sustained gestures were represented in the neural recordings from the participants, T11 and T5 were asked to attempt hand gestures for differing durations using the Gesture Hero Task. FIG. 13, element A shows stills from the Gesture Hero Task. Like its video game namesake (Guitar Hero, Activision) upcoming movements were instructed by falling boxes with a picture of the cued gesture (FIG. 13, element A, Instruction). The participants were asked to attempt (see FIG. 13, element A: Attempt Onset) and maintain the gesture (see FIG. 13, element A: HOLD) when the falling box came in contact with the “attempt line” positioned at the lower third of the screen and to relax (see FIG. 13, element A: Release) after the box fell past the attempt line. Therefore, the attempt period was indicated by the amount of time the box intersected with the line. Since boxes fell at a constant speed, the size of the box was directly proportional to the attempt time, which was either 1, 2, or 4 seconds long. The instruction period, the time it took the box to move from the top of the screen to the attempt line, was four seconds. The intertrial period, the time between the box exiting the attempt line and the appearance of the next gesture box, was 1.3 seconds. As shown in FIG. 13, element B, T11 was asked to attempt six right-handed gestures (index finger down, power grasp, OK, open, key grasp, thumb down) and one left-handed gesture (thumb down). T11 performed the Gesture Hero Task on two session days, each session consisting of ten data blocks and twenty trials per gesture-duration condition. Due to time constraints, data collection with T5 was limited to using a subset of three gestures-index finger down, power grasp, and OK-in one session with twenty trials per gesture-duration condition.

### 2.2 Gesture Information During Sustained Attempts

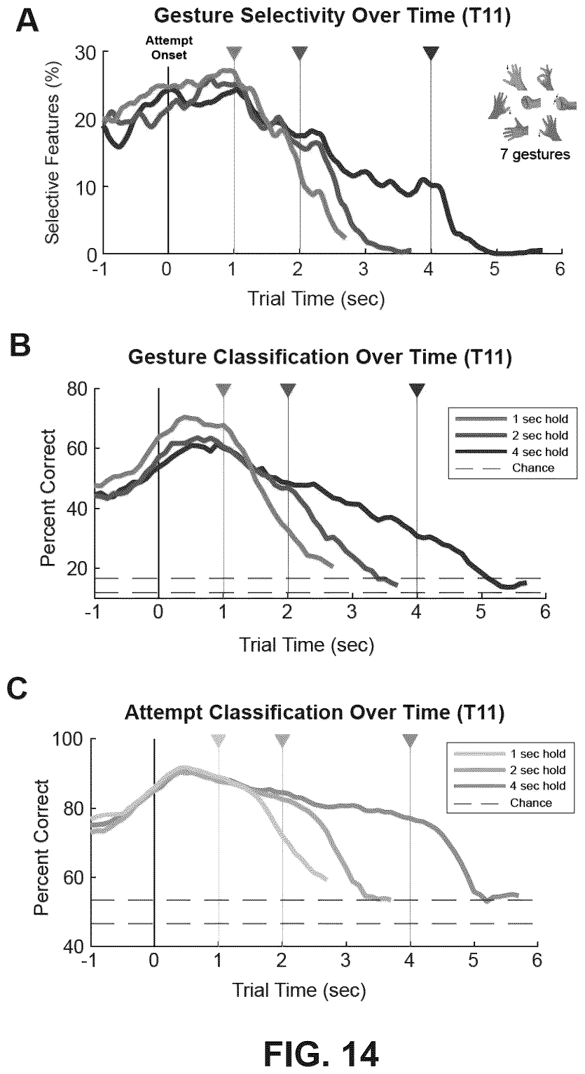

Using the dataset from the Gesture Hero task the representation of gesture information over the course of the different hold durations was evaluated. FIG. 14 shows the gesture information in recordings from T11's motor cortex during the Gesture Hero Task. FIG. 14, element A shows the percent of neural spiking features (TX and SP) selective for gesture type assessed on 300 ms windows incremented in 20 ms increments over each set of trial durations (1s, 2s, and 4 s trials). Features were considered gesture selective in a given time window if they displayed significantly different values across the 7 gesture conditions (KW test, p<0.001). FIG. 14, element B shows the performance of LDA classification in discriminating between the seven gesture conditions across each trial duration. Cross-validated (5-fold) accuracies were computed on classifiers built on data from 500 ms windows stepped in 100 ms increments. Dashed lines reflect the 95% chance interval. FIG. 14, element C shows the performance of LDA classification in discriminating between all gestures and the intertrial period.

Similar to what was observed among neurons in NHPs, gesture-selective activity appears to decrease during isometric holds of greater than 1 second. For example, whereas about 25% of the neural features (TX and SP) recorded from T11 were gesture selective (i.e. displayed significantly different values across gesture conditions; Kruskal-Wallis test, p<0.001) after 1 s holds, 16% of features were gesture selective after 2 s holds and 10% of features were gesture selective after 4 second holds (see FIG. 14, element A). Furthermore, by assessing the performance of an LDA classifier over the trial durations it becomes clear that standard LDA-based decoding approaches would not reliably maintain gesture decoding throughout extended attempt periods (see FIG. 14, element B). For example, during a 4 second sustained gesture attempt, a simple LDA classifier would correctly decode about 60% of 300 ms data samples centered at the 1 s mark after attempt onset, compared to 30% correct decodes at the 4 s mark, representing a 50% decrease in classifier performance. However, it was found that if an LDA classification was applied to the far simpler task of determining whether or not any gesture attempt was being performed (“Attempt Classification”, FIG. 14, element C), then a less drastic drop off in decoding accuracy (11.5% decrease from 1 s to 4 s) was observed.

When applying the same analysis to the neural signals of T5 performing the Gesture Hero task (with only 3 gestures), there was likewise a significant drop off in gesture selectivity, with about 12% gesture selective features at the end of 1 s hold trials, 6% at the end of 2 s hold trials, and 3% at the end of 4 s hold trials. Although gesture classification (LDA) performance assessed over time also showed a decrease throughout T5's sustained gesture attempts, this relative drop off (a 12.3% decrease from 1 s to 4s) was far shallower than T11's, even when compared with LDA classification of T11's data evaluated on the subset of gesture trials performed by T5 (index finger down, power grasp, OK, 35.2% decrease from 1 s to 4s). Curiously, attempt classification of T5 data did not demonstrate a meaningful decrease in accuracy over the trial duration, even revealing the presence of a second “peak” shortly after the end of sustained gesture trials.

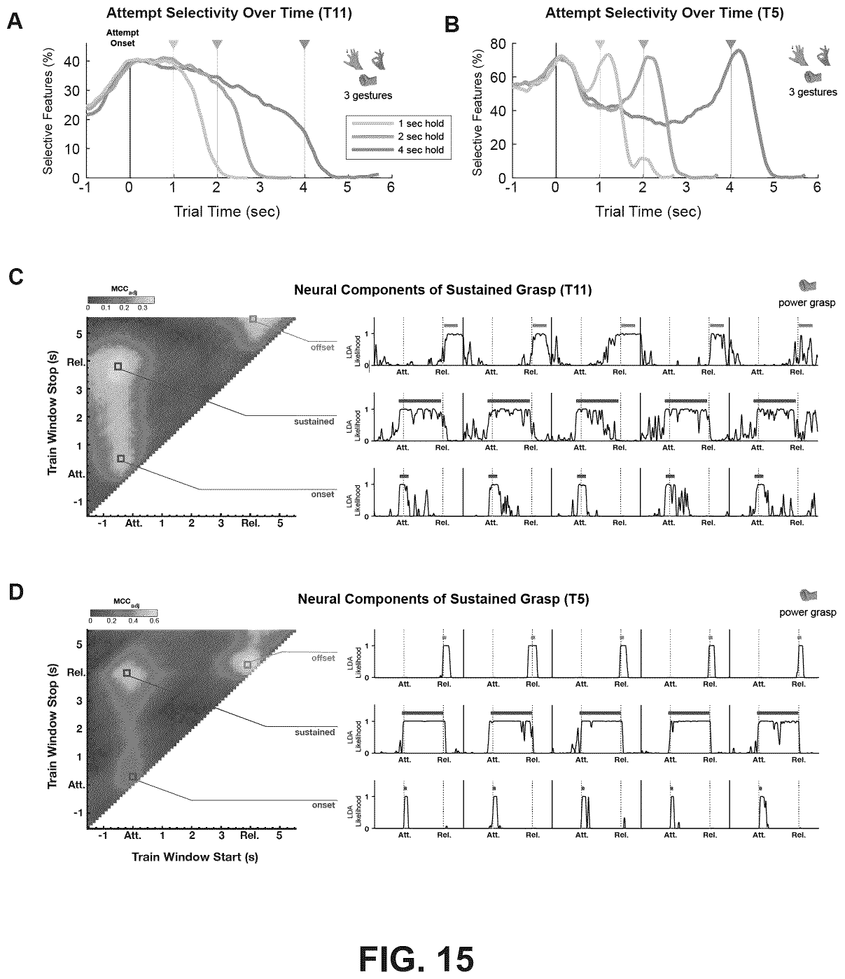

The percent of features that were attempt selective (i.e. demonstrated significantly different values during gesture attempts compared to baseline; Wilcoxon Rank Sum, p<0.001) were assessed during Gesture Hero trials and found notable differences between T11 and T5 in the neural representations (see FIG. 15, elements A and B). Whereas, for T11, the percent of attempt selective features peaked at the beginning of the trial and smoothly declined over time (see FIG. 15, element A), for T5, attempt selectivity exhibited distinct peaks at both the onset and offset of the trial (see FIG. 15, element B).

The presence of “onset” and “offset” responses in T5's neural data resembles previous descriptions of distinct neural activity patterns, or components, associated with the onset, offset, and “sustained” periods of single-gesture drag-and-drop trials performed by other iBCI participants. These neural components were identified by performing an exhaustive grid search of all possible trial-aligned time windows, assessing the ability of a binary LDA classifier to differentiate between neural data collected within and outside of each time window. When applying this approach to the 4 second Gesture Hero trials, peaks were found in classifier performance (measured by an “adjusted” Matthews correlation coefficient corresponding to onset and sustained components in both T11 and T5, but only data from T5 exhibited a distinct “offset” component (See FIG. 15, elements C and D).

The lack of reliable gesture offset components in T11 suggested that the approach of using two independent classifiers to control the onset and offset of sustained gesture attempts would not generalize well for all participants. A new approach was designed that combines the transient, highly gesture-selective signal present at the beginning of a sustained gesture attempt (see FIG. 14, elements A and B) with the more robust, attempt selective signal (see FIG. 14, element C) present throughout the duration of a held gesture.

### 2.3 The Latch Decoder

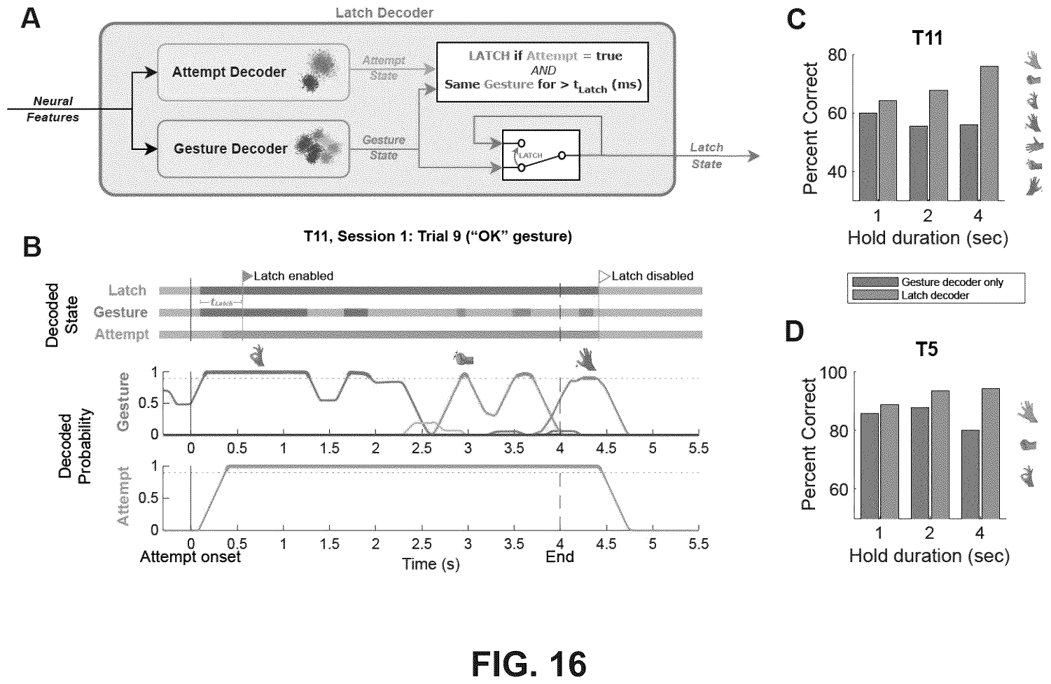

Given that the peak in gesture-related information encoded in precentral neuronal activity was noted to occur at the onset of the attempted gesture, a decoding strategy was developed that would “latch” or maintain the initial decoded gesture: the Latch decoder (see FIG. 16, element A). The Latch decoder consists of two components. One component predicts the gesture type (Gesture), and the other predicts if any gesture is being attempted (Attempt). Initially, the Latch decoder's output (Latch State) directly reflects the Gesture decoder's state (Gesture State). However, when the Attempt State is true and the Gesture State has been the same for 400 ms (tLatch), the Latch State becomes latched to the present decoded gesture type until the Attempt State becomes false.

See FIG. 16, element B, which shows an example of how the Latch decoder operates. The Latch decoder's state becomes latched ˜600 ms after the attempt onset and does not change despite the changes in the Gesture decoder's output. Its output becomes unlatched ˜4.5 sec into the trial when the Attempt State transitions to false. Using this approach on data collected from the Gesture Hero task, it was found that the Latch decoder enabled substantial increases in the percent of correctly decoded time steps compared to using the Gesture decoder alone for both participants (see FIG. 16, elements C and D).

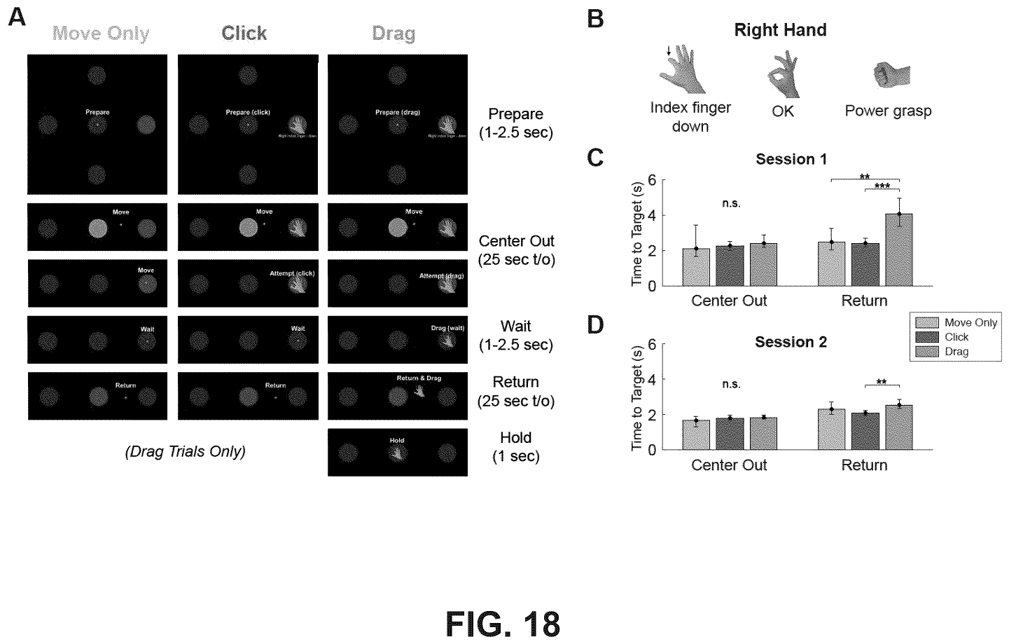

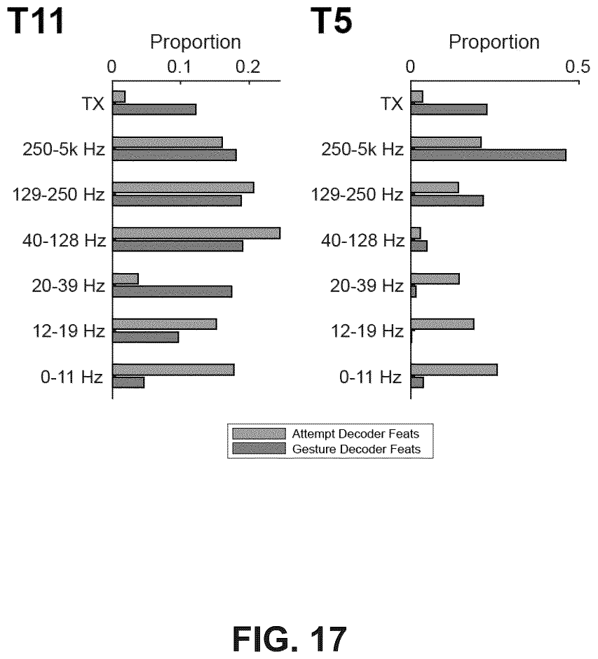

Both the Gesture and Attempt decoders used linear discriminant analysis (LDA) in conjunction with a hidden Markov model (HMM), LDA-HMM. In brief, incoming z-scored features were smoothed with a 100 ms boxcar filter and projected to a low dimensional space before class posterior probabilities were computed using LDA. Emission probabilities were then produced via an HMM, smoothed with a 100 ms boxcar filter, and thresholded (see FIG. 16, element B) to determine the “decoded state” output from each decoder.

Whereas the Gesture decoder was trained to differentiate between all gesture classes (including the relax state), the Attempt decoder was trained on the same data, but all gesture classes were relabeled as a single “attempt” class. A regularization parameter empirically set to 0.3 was used when computing the LDA coefficients, and the class means and covariances used the empirical mean and covariances from the calibration data. For the Gesture decoder, the HMM transition matrix was set to match the gesture state transitions of the calibration task. The HMM transition matrix of the Attempt decoder was manually set to be extra “sticky”, with on-diagonal values of Jan. 10, 2010, to prevent transient misclassification of the attempt signal. Of the 1,344 recorded features (one TX value, one SP value, and the five lower-frequency LFP bands per channel, 192 channels), the top 400 were selected for classification analysis by identifying all gesture selective (or attempt-selective) features (Kruskal-Wallis, p<0.001) and ranking them according to minimum redundancy maximum relevance algorithm. This method allows for optimal feature selection for each decoder individually. For example, when testing the Latch decoder on 4 second hold trials from the Gesture Hero dataset (See FIG. 16, elements C and D), the Gesture decoder utilized TXs, SPs, and higher frequency LFP features, whereas the Attempt decoder used very few TX features and relied more heavily on LFP features (see FIG. 17).

### 3. Mult-Gesture Drag-and-Drop

Rarely are sustained gestures and clicks performed in isolation when using a personal computer or tablet. Thus, a multi-gesture drag-and-drop task was designed to assess how well the Latch decoder enables sustained grasp decoding while an iBCI participant is also controlling cursor kinematics.

### 3.1 Drag-and-Drop Task

The Drag-and-Drop Task consisted of a 2D center out and return task with four outer targets positioned cardinally from the center target. There were three trial variations present in each data collection block (see FIG. 18, element A):

Move Only: Move Only trials represented a simple kinematic task that required the participant to move a circular cursor from the center of the screen to an outer target (Center Out stage), wait for 1 second-2.5 seconds on the outer target (Wait), and move the cursor back to the center (Return). In order to acquire the outer target, the cursor needed to dwell within the target radius for 0.5 seconds.

Click: During Click trials, the participant performed an identical kinematic task as for Move Only trials but was instructed to perform a transient gesture attempt, or “click”, in order to acquire the outer target.

Drag: Drag trials were similar to Click trials, however, once the cursor reached the outer target, the participant was instructed to attempt and hold the cued gesture for 1 second-2.5 seconds and then continue holding the gesture while moving (i.e. dragging) the cued gesture icon from the outer target location back to the center. Drag trials contained an additional 1 second “Hold” stage at the end wherein the participant continued attempting the gesture without kinematic movement.

Each trial began with a random 1 second-2.5 seconds “Prepare” stage (FIG. 18, element A) wherein an outer target was cued by changing from blue to red. In Click trials and Drag trials the outer target was also overlaid with an image of one of the three gestures that they were supposed to perform once reaching the target (see FIG. 18, element B). The words “Prepare (drag)”, “Prepare (click)”, or “Prepare” were visible above the cursor during this stage. Thus, the participant had information on the movement direction, the gesture (if applicable), and the trial type he was about to perform from the beginning of the trial. To provide additional guidance during the task, the words “Move”, “Attempt”, “Drag”, “Return”, and “Hold” were presented above the cursor (see FIG. 18, element A) to instruct the participant during each stage of the trial. During Drag trials, the gesture icon would shrink in size and follow the cursor to represent “dragging” of the icon when the correct gesture was being decoded. If the decoder did not decode the correct gesture, the gesture icon would be “dropped” (i.e. the icon would return to original size and cease moving along with the cursor). Both the Center Out and Return stages had timeouts of 25 seconds.

Participant T11 performed the Drag-and-Drop Task during two sessions, each with a total of 11 blocks. Each block contained 4 Move Only trials (one for each direction), 12 Click trials (one for each direction/gesture combination), and 12 Drag trials (for each direction/gesture combination). The first four blocks were used to calibrate the decoders (steady state Kalman filter) for 2D kinematic decoding and the Latch decoder for gesture decoding) and the seven subsequent blocks were treated as assessment blocks.

All trials in the first block were “open loop” (OL) trials, meaning the computer displayed idealized performance of the Drag-and-Drop task while the participant imagined movements corresponding with the task. For this task, T11 imagined translating his right arm in a horizontal plane to create 2D movement of the cursor and performing the cued gestures with his right hand. For blocks 2-4, kinematic control was gradually given to the participant through stepwise reduction of error attenuation (EA). EA reduces the decoded cursor velocity in the error direction by a factor corresponding to how much assistance was provided to an incompletely calibrated kinematic decoder. For example, EA of 0.5 would reduce the decoded velocity component perpendicular to the cursor-target vector by half. Blocks 2, 3, and 4 had EA values of 0.5, 0.3, and 0.0, respectively, with new Kalman filters generated after each block that incorporated previous blocks' data. For all calibration blocks, gesture decoding was inactivated (i.e. remained completely OL). All seven assessment blocks were performed in “closed loop” (CL), under full participant control.

3.2 Kinematic Performance

Within each trial of the Drag-and-Drop task there were two kinematic tasks: moving the cursor from the center to an outer target (Center Out stage) and returning from the outer target (Return). Despite contextual differences between Move Only, Click, and Drag trials, the instructed task during the Center Out stage was functionally the same between trial types. Thus, as expected, target acquisition times during this stage were not significantly different across trial types (Kruskal-Wallis (KW), p=0.265, see FIG. 18, elements C and D). However, trial timeouts were more common during Drag trials (2.4%) than Click trials (1.1%) and Move Only trials (0.0%).

During the Return stage, whereas Move Only and Click trials were functionally the same, Drag trials required the participant to perform the same kinematic task while simultaneously holding a gesture. T11's median target acquisition times were significantly greater during the Drag trials (3.16s) than for Click (2.22s; Wilcoxon Rank Sum (RS), p=3.92e-07), and Move Only (2.30s; RS, p=0.002) trials. However, this difference was far more noticeable during the first session (see FIG. 18, element C) than the second session (see FIG. 18, element D), suggesting a learning effect. Moreover, when considering Session 2 trials alone, Drag (Return) trial durations were not significantly different from Move Only trials (RS test, p=0.186).

### 3.3 Latch Decoder Performance

During Drag trials of the Drag-and-Drop task, T11 used the Latch decoder to select and maintain selection of gesture icons across three trial stages: Wait, Return, and Hold. The occurrence of gesture decoding errors during these epochs were evaluated and compared performance to what would have occurred if the output of the Gesture decoder component was used on its own. Here, an error is considered an incorrect gesture decode, including a no gesture decode. Note that for the Wait period, to account for variance in reaction times, only steps after the decode onset were considered (correct or incorrect). If there was no decode during the Wait period, then the entire period was counted as incorrect.

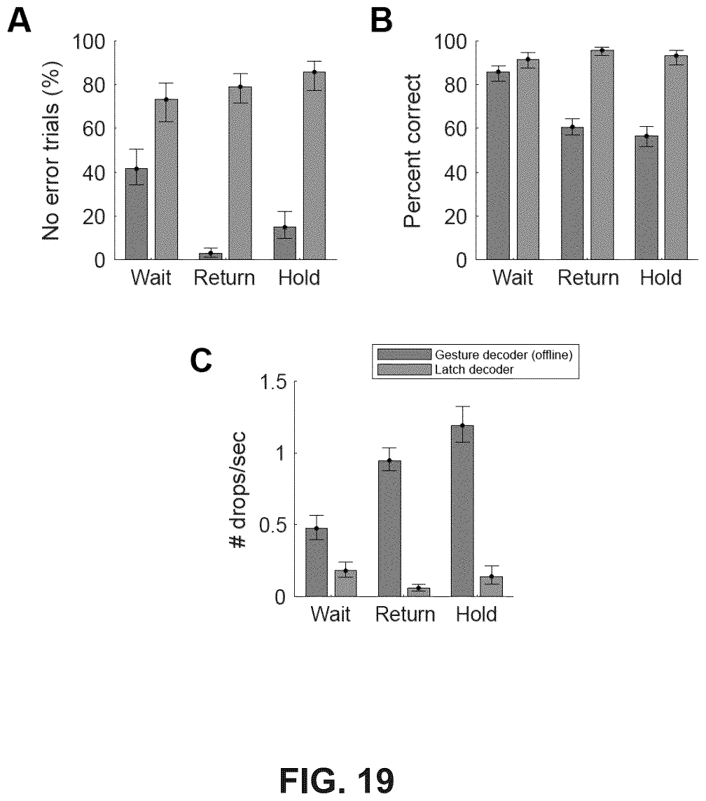

Using the Latch decoder, T11 completed 73% of Wait epochs, 79% of Return epochs and 86% of Hold epochs without a gesture decoding error. By contrast, if the output of the Gesture decoder was used on its own, only 41% of Wait epochs, 3% of Return epochs, and 15% of Hold Epochs would have been completed without error (see FIG. 19, element A). Specifically, during Wait, Return, and Hold epochs, the Latch decoder, on average, output the correct gesture decode for 92%, 96%, and 93% of the duration of each epoch, respectively. Meanwhile, the Gesture decoder output reflected the correct gesture 86%, 61%, and 56% of the duration of Wait, Return, and Hold epochs, respectively (see FIG. 19, element B).

The Latch decoder showed particular promise in preventing unintended drop events during the task, especially during the Return and Hold periods when the gesture attempt was being sustained beyond 1 or 2 seconds. Using the Latch decoder, T11 averaged 0.2, 0.1, and 0.1 drop events per second during the Wait, Return, and Hold periods, respectively. Using the Gesture decoder alone would have yielded 0.5, 0.9, and 1.2 drops per second, respectively.

### B. Experiment 2

This experiment investigated the use of the Latch decoder on its own and in combination with a Lock decoder for even longer duration “hold” actions in the context of controlling a soft-robotic glove. Soft robotic wearables have shown promise as assistive and rehabilitative tools for individuals with motor impairments but lack an intuitive means of control. Intracortical brain computer interfaces (iBCIs) can enable people with tetraplegia to control external devices such as soft robotic wearables using highly precise predictions of motor intent. The present experiment paired iBCI neural decoding with a soft robotic glove (SRG) to allow participants with tetraplegia the ability to move their hands again for both quick grasps and sustained grasps. The present experiment also studied how proprioception from SRG-induced movement may impact neural decoding.

### 1. Neural Recording and Soft Robotics Methods

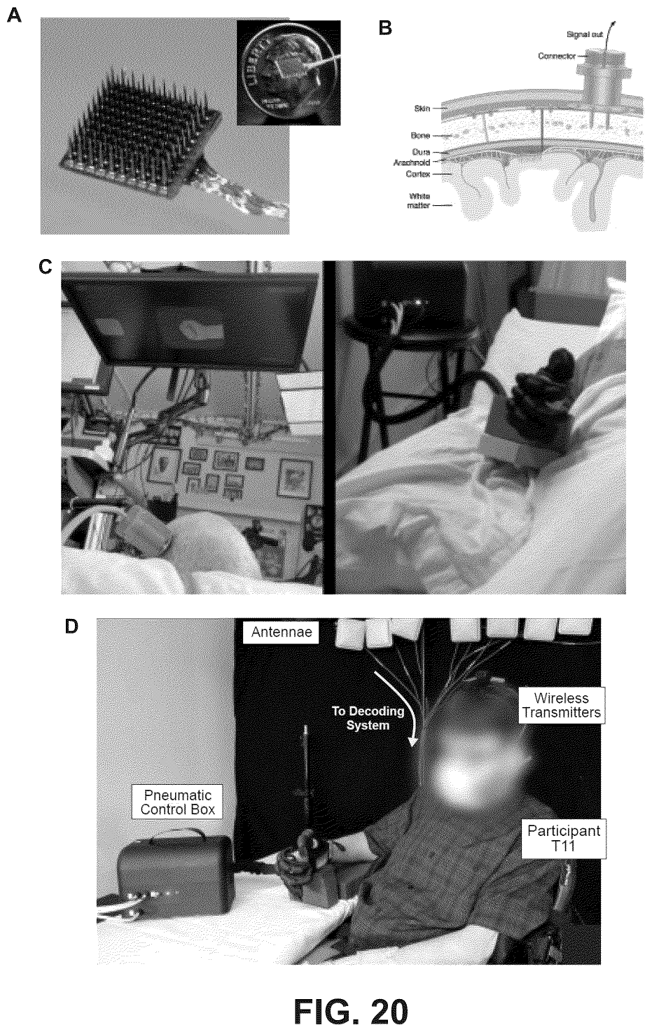

The first participant (known hereinafter as “T11”) was a 38-year-old male with tetraplegia due to C4 AIS-B spinal cord injury. T11 previously had two 96-channel microelectrode arrays implanted on his left precentral gyrus (PCG). The second participant (known hereinafter as “T5”) was a 69-year-old male with tetraplegia due to C4 AIS-C spinal cord injury. T5 also had two 96-channel microelectrode arrays implanted on his left PCG. Intracortical recordings were made via a wireless broadband iBCI. FIG. 20, elements a, b, c, and d show various aspects of the participants and the micro-electrode arrays. Neural features extracted from the signals received from the two 96-channel microelectrode arrays included threshold crossing evens and power in the spike band (250 Hz-5000 Hz) in 20 ms bins. A discrete decoder (e.g., an LDA-HMM) was used to predict intended gesture states.

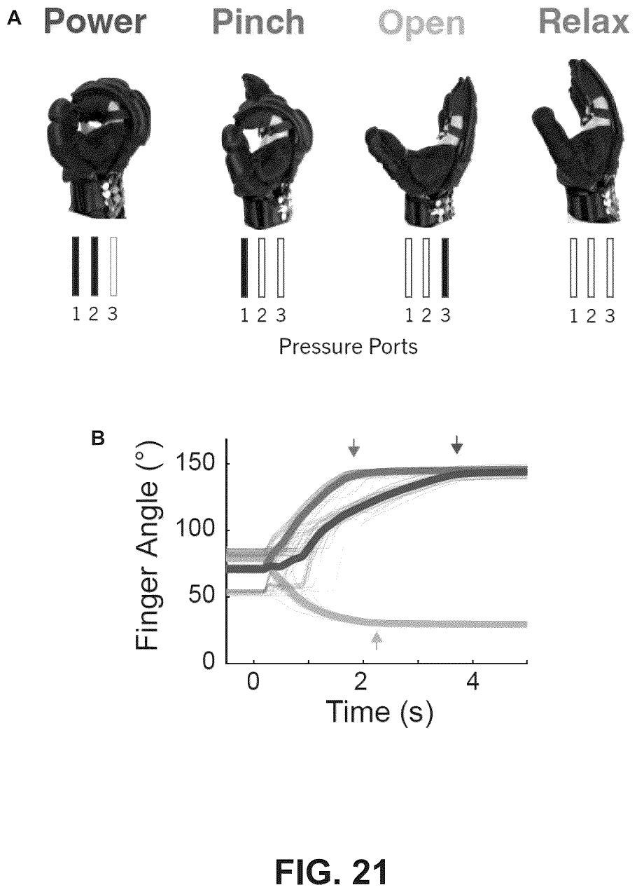

The soft-robotic glove (SRG) was a textile-based soft robotic that can at least partially encase the hand and was driven by pneumatic pressure. The control box connected to the SRG had 3 pressure ports and the SRG included pressure sensors and a bend sensor on the index finger (See FIG. 20, element D). The SRG was tested in four hand states (1) Power (complete fist), (2) Pinch (pinch the thumb and index finger), (3) Open (hand open and thumb spread from fingers) and (4) Relax (hand partially bent) (see FIG. 21, elements A and B). The SRG can take about 2 seconds to about 4 seconds to perform a grasp (1-4).

### 2. Development of Latch and Lock Controller for SRG

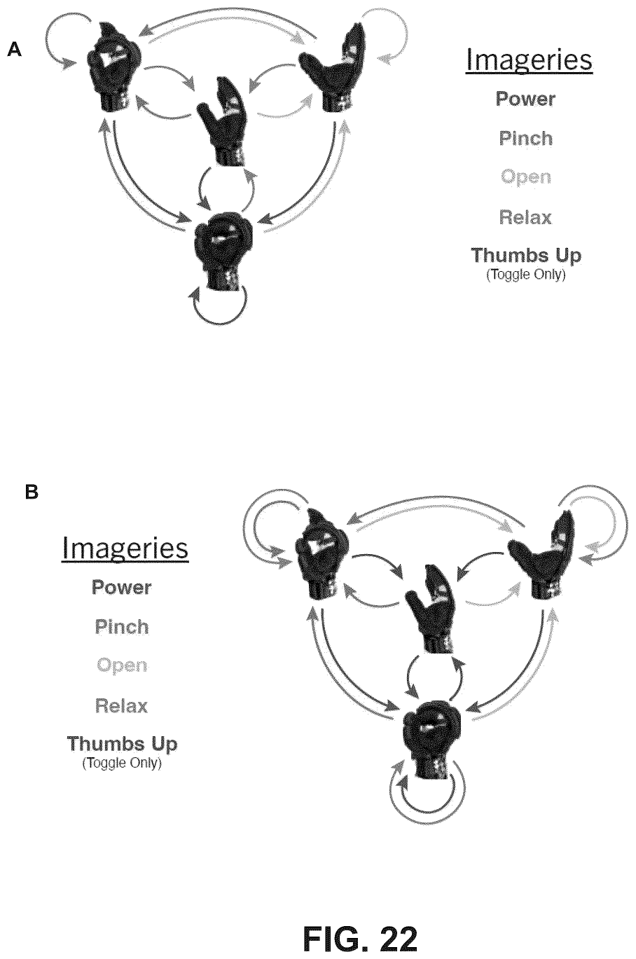

A Latch controller was developed where the SRG poster directly reflects the decoder output for each of the four hand states using intuitive imagery. The Latch Controller is similar to that described in Experiment 1 (e.g., see FIG. 14, elements A, B, and C and FIG. 16 and included both a gesture and attempt decoder to improve sustained grip decoding. FIG. 22, elements A and B show illustrations of the continuous controller (element A) and the toggle controller (element B). The Latch decoder is similarly described as the Continuous controller where SRG posture directly reflects decoder output. This is in contrast to a Toggle Controller were the SRG “Toggles” between states after transient attempts for 5 states with less intuitive imagery. In addition to the Latch Controller a Latch and Lock Controller was developed with an additional “lock” state (see FIG. 23, element A). If the SRG maintained one of the four hand states for 3 seconds, then the SRG would be locked into the current state until a different non-Relax state was decoded (see FIG. 23, elements B and C). This maintained intuitive imagery of Latch control (e.g., used for quick grasps) while matching the long hold performance capabilities of the Toggle Controller.

### 3. Sensory Feedback Effects Using SRG

The neural representations of visual feedback (V) and proprioception (P) using the SRG were systematically evaluated. When T11 was simultaneously attempting grips (ACTIVE) then there were no significant differences between feedback conditions. During passive observation (PASSIVE) there was neural activity related to visual feedback (V) but not proprioceptive feedback (P).

### 4. Controller Comparison

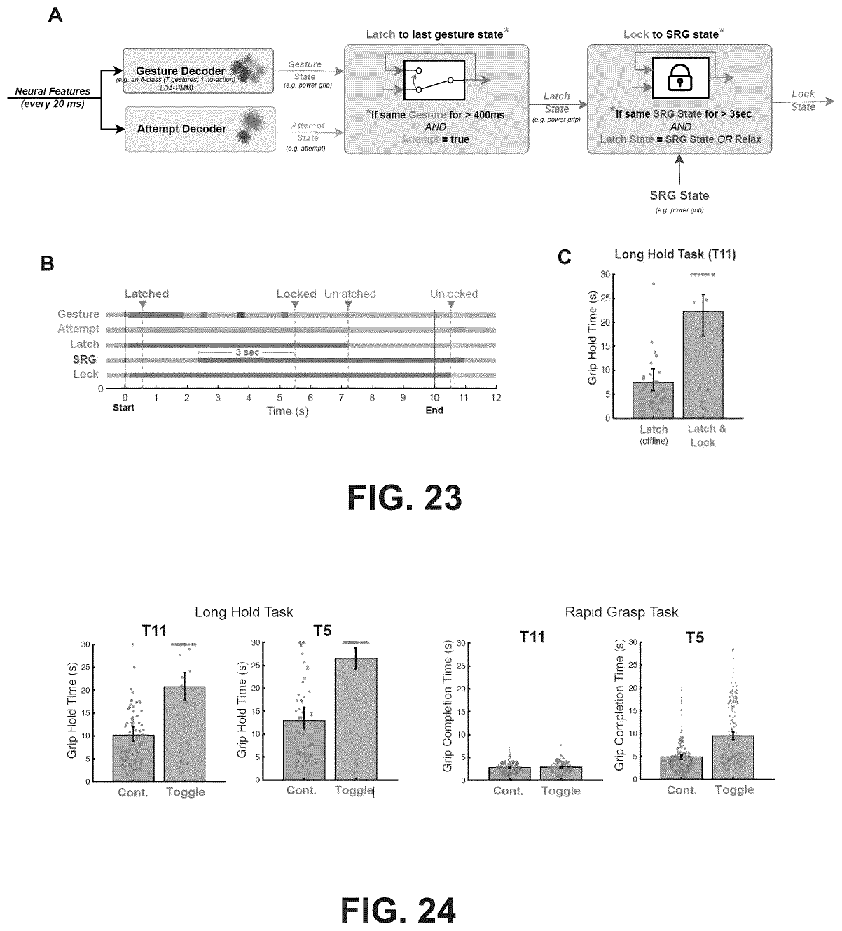

As shown in FIG. 24 Both participants used both SRG control approaches in a Long Hold Task (e.g., attempt to maintain SRG grip for up to 30 seconds) and the Rapid Grasp Task (e.g., rapidly switch between pseudo randomly cued grip states (of the 4 hand states). For both participants, the Toggle Controller allowed for longer hold times. For T5, the Continuous Controller allowed for faster grip switching. T11 preferred the Toggle Controller and T5 preferred the Continuous Controller.

From the above description, those skilled in the art will perceive improvements, changes, and modifications. Such improvements, changes and modifications are within the skill of one in the art and are intended to be covered by the appended claims.

The following is claimed:

1. A system comprising:
at least one neural recording device configured to record at least one neural signal of a user;
a controllable device; and
a controller in communication with the at least one neural recording device and the controllable device, the controller comprising:
a non-transitory memory storing instructions; and
a processor configured to execute the instructions to:
receive the at least one neural signal of the user from the at least one neural recording device;
extract at least one neural feature from the at least one neural signal of the user;
execute a Latch decoder configured to determine whether an action should be performed and a period of time the action should be held, wherein the Latch decoder comprises a Gesture Type decoder and an Attempt decoder, and
if the action should be performed, then control the controllable device to perform the action for the period of time, and
if the action should not be performed, then control the controllable device to remain in a waiting state.

2. The system of claim 1, wherein the Gesture Type Decoder:
determines whether the user is thinking of attempting to perform a known gesture of a plurality of known gestures;
if the user is thinking of attempting to perform the known gesture, determines which type of known gesture of the plurality of known gestures; and
outputs an action command to control the controllable device based on the type of known gesture or a no action command if no known gesture determined.

3. The system of claim 2, wherein the Attempt decoder:
determines whether the user is thinking of attempting to perform any known gesture of the plurality of known gestures; and
outputs a Yes attempt state if an attempt is determined or a No attempt state if no attempt is determined.

4. The system of claim 3, wherein the Gesture Decoder and/or the Attempt Decoder are discrete classifiers.

5. The system of claim 3, wherein the Latch Decoder outputs:
the action command for a finite time if the type of known gesture is determined for less than a first time;
a latch on the action command if the type of known gesture is determined for the first time and a Yes attempt state is determined for a second time, wherein the latch causes the controllable device to hold the action; or
a no action command if no known gesture type is determined.

6. The system of claim 5, wherein the Latch Decoder outputs
a stay latched at the action command if the Yes attempt state is determined at a third time after the second time, wherein the controllable device holds the action at the third time, or
an unlatch command if the No attempt state is determined at the third time after the second time, wherein the unlatch command controls the controllable device to stop the action.

7. The system of claim 1, further comprising instruction to execute a Lock decoder to lock the controllable device to perform the action for an extended period of time, longer than the period of time, until an unlock gesture is decoded by the Latch Decoder.

8. The system of claim 7, wherein the Lock decoder locks the controllable device to perform the action for the extended period of time if the period of time the action is performed reaches a predetermined lock time.

9. The system of claim 8, further comprising locks the controllable device to perform the action for the extended period of time, based on physical feedback from the controllable device that the action is being performed.

10. The system of claim 1, wherein the controllable device is at least one of: a processor connected with a visual display, a robot configured to perform at least one task, an exoskeleton configured to be worn on at least one body part of the user to move the at least one body part, a robotic limb representing at least a portion of a limb of the user, or at least one electrode configured to provide at least one functional electrical stimulation (FES) to the user to cause a muscle contraction.

11. A method comprising:
receiving, by a system comprising a processor, at least one neural signal of a user from at least one neural recording device in communication with the processor;
extracting, by the system, at least one neural feature from the at least one neural signal of the user;
executing, by the system, a Latch decoder to determine whether a controllable device should perform an action and a period of time the action should be held for, wherein the Latch decoder comprises a Gesture Type decoder and an Attempt decoder,
if the action should be performed, then controlling, by the system, the controllable device to perform the action for the period of time; and
if the action should not be performed, then controlling, by the system, the controllable device to remain in a waiting state and/or a previous state.

12. The method of claim 11, further comprising executing the Gesture Type decoder within the Latch decoder, wherein the executing comprises:
determining, by the system, whether the user is thinking of attempting to perform a known gesture of a plurality of known gestures;
if the user is thinking of attempting to perform the known gesture of the plurality of known gestures:
determining, by the Gesture Type decoder, which type of known gesture of the plurality of known gestures the user is thinking of attempting to perform; and
outputting, by the system, an action command to the controllable device to control the controllable device based on the type of known gesture; or
if the user is not thinking of attempting to perform the known gesture of the plurality of known gestures:
outputting, by the system, no action command.

13. The method of claim 12, further comprising executing the Attempt decoder within the Latch decoder, wherein the executing comprises:
determining, by the system, whether the user is thinking of attempting to perform any known gesture of the plurality of known gestures; and
outputting, by the Attempt decoder, a Yes attempt state if an attempt is determined or a No attempt state if no attempt is determined.

14. The method of claim 13, wherein the Gesture Decoder and/or the Attempt Decoder are discrete classifiers.

15. The method of claim 13, wherein the executing the Latch decoder further comprises outputting, by the system:
the action command to the controllable device for a finite time if the type of known gesture is determined for less than a first time;
a latch on the action command to the controllable device if the type of known gesture is determined for the first time and a Yes attempt state is determined for a second time, wherein the latch causes the controllable device to hold the action; or
no action command to the controllable device if no known gesture type is determined.

16. The method of claim 15, wherein the executing the Latch Decoder further comprises outputting, by the system:
a hold the action command if the Yes attempt state is determined at a third time after the second time, wherein the controllable device holds the action at the third time, or an unlatch command if the No attempt state is determined at the third time after the second time, wherein the unlatch command controls the controllable device to stop the action.

17. The method of claim 11, further comprising executing, by the system, a Lock decoder to lock the controllable device to perform the action for an extended period of time, longer than the period of time, until an unlock gesture is decoded by the Latch Decoder.

18. The method of claim 17, wherein the executing the Lock decoder further comprises locking, by the system, the controllable device to perform the action for the extended period of time if the period of time the action is performed reaches a predetermined lock time.

19. The method of claim 18, wherein the locking is further based on physical feedback from the controllable device that the action is being performed.

20. The method of claim 11, wherein the controllable device is at least one of: a processor connected with a visual display, a robot configured to perform at least one task, an exoskeleton configured to be worn on at least one body part of the user to move the at least one body part, a robotic limb representing at least a portion of a limb of the user, or at least one electrode configured to provide at least one functional electrical stimulation (FES) to the user to cause a muscle contraction.
